(19) United States
(12) Patent Application Publication
(10) Pub. No.: US 2003/0046152 A1
(43) Pub. Date: Mar. 6, 2003

(54) Electronic advertisement system and method

(76) Inventors: Todd Robert Colas, Littleton, CO (US); Craig Bentley Roffman, Simi Valley, CA (US)

Correspondence Address: Law4IP, Noreen O'Hara Welch, 94 Eldrid Drive, Silver Spring, MD, 20904-2912, US

(21) Appl. No.: 09/935,120

(22) Filed: Aug. 22, 2001

(51) Int. Cl. G06F 17/60

(52) U.S. Cl. 705/14

(57) ABSTRACT

A system and method for the preparation and administration of advertisements for electronic and print publishing, and other advertising media is provided. The present system and method is directed to an interactive network-accessible computer-assisted cooperative preparation of advertisements governed by business rules provided by both a Company advertiser and a media Publisher. Using the system and method of the invention Companies and Publishers are able to cooperate (1) in the joint creation, editing, and arrangement of text, images, audio, animation, and video for inclusion in a publication's advertising media spaces and (2) in the joint administration of the advertisement preparation process. The invention has application in any visual, audio, electronic and print media that can support perusing of ads by potential purchasers. Media which provide such presentations include newspapers, magazines, trade journals, as well as computer-based applications, such as on-line catalogs, yellow pages, want ads, and other network-accessible advertising platforms and other advertising media including movie theatre ads, billboards, and radio ads.

### BACKGROUND OF THE INVENTION

1. Field of the Invention

The present invention relates to the preparation and administration of advertisements for electronic and print publishing, and other advertising media. Particularly, the present invention is a system and method directed to interactive network-accessible computer-assisted cooperative preparation of advertisements for print, electronic, and other advertising media and concurrent administration of the advertisement preparation process by a Company advertiser and a media Publisher. Most particularly, the present invention provides a system and method for Companies and Publishers to cooperate (1) in the joint creation, editing, and arrangement of text, images, audio and video for inclusion in a publication's advertising media spaces and (2) in the joint administration of the advertisement preparation process.

The present invention has application in any visual, audio, electronic and print media that can support perusing of ads by potential purchasers. Media which provide such presentations include newspapers, magazines, trade journals, as well as computer-based applications, such as on-line catalogs, yellow pages, want ads, and other network-accessible advertising platforms and other advertising media including movie theatre ads, billboards, and radio ads.

2. Description of the Related Art

The visual and audio presentation of advertisements of available products to prospective buyers is a known sales technique. As a non-limiting example, an advertisement (hereinafter ad) commonly referred to as a “Photo Gallery” or gallery ad is a type of display ad commonly used by most major and mid-size Real Estate Companies. These gallery ads combine a number of individual ads or “Ad Boxes” in an N×M matrix or Ad Master format. Each individual Ad Box contains text and images entries of properties for sale, and possibly contains one or more filler boxes if too few Ad Boxes are available, all under a Real Estate Company logo. These photo gallery ads can be as small as a few columns and as large as a whole page. The number of Ad Boxes in each gallery ad is dependent on both the total ad size available to a Real Estate Company and the layout preferences of both the Real Estate Company and the Publisher. A typical Sunday Real Estate section of a printed newspaper may contain as few as four Ad Boxes in a small gallery ad and as many as fifty-three in a full-page gallery ad.

As another non-limiting example, an ad commonly referred to as an “in-column” ad is a type of display ad commonly used by Automobile Dealership Companies, Real Estate Companies, Employment Advertisers, etc. The in-column ad comprises a single Ad Box containing an entry for a text description and, optionally, an entry for an image of an item that is for sale, under an optional Company logo. The in-column ad is intended to fit into a publication's standard classified advertising format, which is usually columnar. The in-column ad is a stand-alone ad that can include enhanced borders and a line of text or signal (sig) line to attract potential buyer attention to the ad. The in-column ad can appear in any section of a publication.

The component ads have several attributes in common. For example, component ads are for individual items and are usually prepared by a single Company employee. Another Company employee usually accomplishes the layout of individual ads into a final ad. Further, when individual ads are presented to the ad originator they are in a standard or default Ad Box format as opposed to the Ad Master format of the section of the publication in which they are to appear. That is, an ad for an individual item is created and reviewed in a default Ad Box format comprising one or more entries but is presented to the consuming public in a publication's Ad Master format.

FIG. 4A illustrates a non-limiting example of a typical Real Estate Company gallery ad, i.e., a matrix or Ad Master format 40 having multiple individual Ad Boxes 41 as components. This format may be used in any selling situation in which a column and row gallery arrangement or matrix, of product image entries and accompanying description entries contained in individual Ad Boxes, is intended to allow a seller to present an array of products. This array presentation enables a prospective buyer to easily ‘comparison shop’ multiple product offerings by scanning the gallery, e.g., in a single page of a newspaper. The shopper can also be conveniently supplied with pointers to people, places, and web sites for obtaining further information within the format of a gallery ad. As a further non-limiting example, FIG. 4B is an example of a typical Real Estate Company in-column ad 42 showing a single Ad Box 41 with a plurality of entries. This type of ad format applies to Web pages in which each Ad Box corresponds to a frame and each frame is independent of every other frame and can contain links to other Web pages containing more detailed item information.

Many inventions are directed to how best to fill a given presentation area (such as a page) by addressing different aspects of manipulating type and/or images to fit a given shape or newshole. (U.S. Pat. No. 4,829,470, 5,287,443, 5,113,488, 4,755,955, and 5,079,724). Other patents disclose how to arrange stories and ads, for example, to fill a given area without manipulating the content per se. (U.S. Pat. No. 5,390,354). Still other patents disclose layout systems that impose a predetermined layout style on electronic and print media using pre-specified rules. (U.S. Pat. No. 5,953,733, 5,031,121). Additionally, document preparation systems are known that are directed to multicolumn formats (U.S. Pat. No. 5,633,996) and flowing content around elements which are fixed by location within documents (U.S. Pat. No. 5,214,755). None, however, are directed to first laying out Ad Box entries by Company Sales Agents, according to a pre-specified default format captured by associating business rules with each entry. None are directed to subsequently either specifying where and how the ad is to appear in a publication. None are directed to arranging the completed Ad Boxes in an array or gallery ad. None employ Ad Master format and ordering rules which have been jointly established by a Company and a Publisher as business rules. Further, none address administering the inter-organization ad preparation process.

In print, electronic, and other media all ads are treated as layout elements within a publication or other media presentation (e.g., Web page). While many patents teach inventions for accomplishing the layout of a publication or a presentation as a whole, facilitating and enabling the participation of the ad-placer (i.e., the Company advertiser) in the preparation and layout process has not been the focus of layout innovations. Many ads have special problems because they include multiple time-sensitive items for presentation to a purchasing audience in a complex format combining text elements and images. Typically, for such ads, each item being advertised, e.g., a property or a vehicle, is being offered for sale by an individual Company Sales Agent. The ad is individually prepared for inclusion in a publication by that Company Sales Agent, and may be sold or withdrawn and need to be replaced, or the ad image or text may need to be replaced or edited. That is, partial replacement and editing, as directed by one or more of many individual Company Sales Agents, is a frequent request for this type of ad. This type of flexibility requires a close working relationship between a Company and its Publisher. Prior art systems have not adequately addressed the needs of this community of cooperating users. Furthermore, prior art systems have focused primarily on the publishing-related technology and not the business process of administering the interaction between the Companies and Publishers for the creation, editing, revision and publishing of ads in print and electronic media. And, while many rule-based systems for publishing layout systems exist, these prior art systems have not addressed extending these rule-based publication layout systems beyond a publication's internal environment to an external community of advertising Companies.

FIG. 1 illustrates a typical prior art process for placement of a gallery ad in a newspaper by Company. Gallery ads typically appear on the weekend, including Friday. In prior art processes, as many as four days of intensive manual preparation precedes final publication of gallery ads in newspapers. FIG. 1 illustrates a time line for such a prior art process in which individual Company Sales Agents must have their individual gallery Ad Boxes ready by Monday morning 100. A Company Administrator must collect these inputs 101, lay them out in an Ad Master for a gallery ad, and send them to a newspaper by a Tuesday deadline. Newspaper advertising personnel then enter the text 102 and coordinate the images with the text 103 and finally assemble all the parts 104 by Wednesday, for delivery in proof form 105 to the Company 106 for review by Thursday. The Company Administrator makes corrections and changes to the proof 107 and returns the corrected copy of the gallery ad to the newspaper where the newspaper's PrePress personnel incorporate these changes 108. A second proof of the gallery ad is returned to the Company 109, provided there is enough time left before the gallery ad must go to press, the Company Administrator makes any final corrections and changes 110, and then returns the final corrected proof to the newspaper 111 by a Thursday deadline. Late corrections may or may not get made. Often, late proof corrections are not made and the Company is given a credit 112-114.

This prior art process for creating gallery ads is typical of other prior art ad creation as well. Other ad processes may be more or less complex. For example, in-column ads do not have the complexity of gallery ads. However, both of these types of ads suffer from an error prone and labor-intensive production process that results in ads that frequently do not reflect the most recent information. Often, the published ad is out-of-date because of the submission and proof correction deadlines. The text and image appearing in print are not for the same item because in the prior art they are separately submitted items that are not labeled properly by a publication's advertising coordinator, e.g., newspaper advertising coordinator 108. In the prior art, the newspaper receives ad entries in pieces, with the text entries for each Ad Box handwritten or typed. The image entries are either attached in the form of hard copy with a paper clip, or on a 3.5-inch floppy diskette, on a CD-rom, in an e-mail, etc. A typical rate for prior art photo gallery ads is at least one Ad Box in forty percent of the gallery ad submissions per week. Because the prior art process of assembling ads is so time consuming, a Company has little opportunity to change out already submitted Ad Boxes before the proof correction deadline. Similar problems exist with the prior art for other types of ads appearing in other media.

Ads appearing in electronic and other media do not have the stringent publication deadline dilemma common to printed media ads. However, there is no recognized standard for preparation and administration of ads placed in electronic and other media. Such ads are usually handcrafted by the programming, production, and graphic artist staff of the media Publisher from individual inputs provided by Company personnel. Thus, the electronic and other media ad preparation and administration processes experience the same problems as printed ads.

### SUMMARY OF THE INVENTION

Thus, there is a need for a more efficient and less error-prone system and process for implementing and managing the life-cycle stages of ads appearing in print, electronic and other media. The present invention provides a network-accessible computer-based system and method for producing an ad and for administering its life cycle, as illustrated in FIG. 14. The system and method of the present invention facilitate Company Sales Agent composition of individual Ad Boxes and provide internal Company review, approval and submission to a Publisher that is significantly more convenient, more accurate, and more efficient than the prior art.

In a preferred embodiment, the system and method of the present invention comprises data processing means, a Company and Publisher database 500, and network means which, in one alternative preferred embodiment, is a Hosted system accessed over the internet using a Web browser. This system and method comprises means for Company Sales Agents to create, edit, and store a plurality of Ad Boxes whose entries correspond to individual items being offered. It also includes means for layout of individual Ad Boxes as components of Ad Masters using Ad Master templates. Finally, it includes means for review, correction and submission of laid out ads to at least one Publisher's personnel who pass the final approved Ad Master through at least one Publisher's publication process. In a preferred embodiment, the system and method of the present invention further comprises means for Publishers to specify publication style rules and for Companies to capture their requirements as business rules, both stored in a Company and Publisher database 500. The system and method of the present invention further comprises means for enforcement of these rules during the ad creation and approval process. Finally, the system and method of the present invention comprises means for Companies to receive back their reviewed Ad Master submissions from Publishers, to correct them and turn them around one or more times, and for Publishers to receive final, corrected Ad Masters from Companies for publication.

In a preferred embodiment, the time frame from Ad Box creation to Ad Master acceptance for publication is at most four days, e.g., Monday to Thursday, for a gallery ad and by 5 PM the previous evening for the next day's in-column ads. Other time frames can be defined for each ad type and publication media.

These personnel roles and administrative deadline rules are incorporated into Ad Box and Ad Master templates stored in a Company and Publisher database 500 and enforced by the system and method of the present invention when ads are created and submitted for publication. These roles and rules are completely customizable at implementation of an embodiment and at any time during the operation of the system and method of the present invention.

Each Ad Box stored in a Company and Publisher database 500 can contain entries which describe an item to be made available through the ad created by the system and method of the present invention, e.g., images, text, audio, video, animation, Web page link, etc. The system and method of the present invention is not limited to items for sale, but also extends to such items as lend themselves to presentation in various Ad Box formats and includes want ads (employment), service ads, personal ads, movie previews, etc.

FIG. 2A illustrates a weekly time-line showing pre-press activities 200-202 as the steps of a preferred embodiment of the current invention for a gallery ad published in a printed newspaper. In this example, a network-accessible and computer-based Hosted system and method according to the present invention is the infrastructure supporting the activities shown. Further, in this example, there are four personnel roles of which Sales Agent and Administrator are the two Company roles and Super Administrator and PrePress Administrator are the two Publisher roles. The newspaper deadline for submission of a final, corrected proof conforms to the newspaper industry's deadline, which is the close of business on Thursday for that weekend's ads. However, due to the reduced turnaround time resulting from use of the system and method of the current invention, in this preferred embodiment, any of the three Company activities 200-202 can take place on any of Monday through Thursday, but they must take place in order:

entry of text, headings, banners, photos 200 by Company Sales Agents;

selection of individual ads for inclusion in photo gallery ad 201 by Company Administrator; and

production, review, and correction of ad proof 202 by Company Administrator and Publisher Super Administrator.

By Thursday, in this embodiment, the Publisher Super Administrator must submit “camera ready” gallery ad(s) to the Publisher 203, which can be in either hard copy or electronic format, or both. In one alternative embodiment, the Publisher Super Administrator notifies the Publisher PrePress Administrator by e-mail that the gallery Ad Master is ready to be picked-up 204. In another alternative embodiment the “camera ready” ad is e-mailed by the Publisher Super Administrator directly to the Publisher PrePress Administrator. Submission of a completed gallery Ad Master can take place on any of Monday through Thursday, according to the present invention.

FIG. 2B illustrates an embodiment of a daily timeline for creation and submission of an in-column ad. In a preferred embodiment, the Administrator sets the day and time deadlines for each day's in-columns ads and these may vary. Note that for an in-column ad there are fewer roles, namely, a Company Sales Agent and an Administrator.

In a preferred embodiment, the Publisher's pre-press personnel are not involved in the preparation of an in-column ad. For an in-column ad, there is only one Ad Box per Ad Master and only one active Ad Master template, although there may be several different Ad Masters. The Administrator lays out each Ad Master by creating a corresponding template. For an in-column ad, the Classification selection made by the Company Sales Agent causes the Ad Box created by the Company Sales Agent to be associated with the predetermined active Ad Master template for that Publisher for that Classification. In an alternative preferred embodiment, the Company Sales Agent can choose between prestored Ad Master templates for a given type of in-column ad, thereby varying the format of entries for in-column ads on an individual Company Sales Agent basis.

While only two types of ad are discussed herein with specific types of roles for each, the preparation and administration of any type of print, electronic, or other media ad can be supported by the system and method of the present invention. The formats, deadlines, and processes can be varied by varying the corresponding business rules captured in the Company and Publisher database 500 and by distributing responsibilities across more or fewer roles. That is, the cooperative ad preparation and administration paradigm of the present invention can apply to any ad preparation and administration situation. This is accomplished by customizing the business rules stored in the Company and Publisher database 500 and the roles and their distribution across the Company and Publisher personnel.

The system and method of the present invention provide significant advantages over the prior art:

the Company placing ads is responsible for establishing the business rules for its internal ad preparation process and for joint administration of its ad approval process;

the ad Publisher is responsible for specifying publication style and jointly administering the publication process of ads and not their creation and editing;

the ad Publisher is assured that submitted ads conform both to the Company's rules and the publication's style standards because both sets of rules are imposed and enforced during the ad preparation process;

the Company is in complete control of ad creation, editing, and storage as well as submission to a Publisher;

the Company has a reduced lead time for submission of the final ad which improves the likelihood that the ad is correct, as of publication;

the ad creation and publication process is more predictable; and

the business process for ads has been made more efficient for both the Company and the Publisher by being flexibly standardized.

Other features and advantages of the present invention will become apparent from the following description taken in conjunction with the accompanying drawings.

### BRIEF DESCRIPTION OF THE DRAWINGS

For a more complete understanding of the present invention, reference is made to the following drawings, in which:

FIG. 1 is a weekly timeline for the steps of photo gallery ad production according to the prior art.

FIGS. 2A-B are respective weekly timelines for the steps of gallery ad and in-column ad production according to the present invention.

FIGS. 3A-C is a Company and Publisher database schema for a database of ad templates and in-progress and completed ads.

FIG. 4A is a typical gallery ad produced by the current invention for a Real Estate Company.

FIG. 4B is an example of an in-column ad produced by the current invention for a Real Estate Company.

FIGS. 5A-5C are overview flow diagrams of some of the ad production steps shown in FIG. 2A, as performed the preferred roles for Company and Publisher personnel involved in the process of preparation and administration of gallery ads.

FIG. 6 is a process flow for the activities performed by a Company Agent working on Ad Boxes for inclusion in a gallery ad.

FIG. 7 is a process flow for the activities performed by an Administrator working on Ad Masters for gallery ads.

FIG. 8 is a process flow of the activities performed by a Publisher Super Administrator after receiving notification that a Company's Ad Masters are ready to be retrieved and reviewed for publication for a gallery ad.

FIG. 9 is a process flow of the activities performed by Publisher PrePress Personnel for a gallery ad.

FIGS. 10A-C illustrate that an individual Ad Box comprises a plurality of entries at particular line locations relative to the top of an Ad Box.

FIGS. 11A-C illustrate that entries for Company Sales Agent name or Company name and telephone number can be on separate lines of an Ad Box or extend across more than one line.

FIGS. 12A-B illustrate positioning of a dollar amount entry either entered below the body entry of an Ad Box or in the text entry below the body entry of an Ad Box.

FIG. 13 illustrates a gallery ad with a Bottom Filler Ad of three Ad Boxes in width.

FIG. 14 illustrates a networked system according to the present invention comprising a plurality of Companies, Publishers, Hosts and Company and Publisher databases.

FIGS. 15A-B illustrate Company Agent sign-on for a non-limiting example of a Real Estate Company.

FIG. 15C illustrates a listing of a Company Agent's private gallery of Ad Boxes that, in a preferred embodiment, is always presented to a Company Agent at sign-on.

FIG. 15D illustrates the initial page for an Automobile Dealership.

FIG. 15E illustrates the list of vehicle Ad Boxes presented at sign on to an Automobile Dealership Sales Agent.

FIGS. 16A-C illustrate the screens for input of item detail entries by a Company Agent and the resulting Ad Box, for a non-limiting example of a Real Estate Company.

FIG. 16D illustrates the screen for input of Company Agent information that must be supplied for every Ad Box, in a preferred embodiment.

FIG. 16E illustrates vehicle detail entry for an in-column ad for an Automobile Dealership.

FIG. 16F illustrates Ad Box entry input for Automobile Dealership in-column ads.

FIG. 16G illustrates a scheduling calendar for in-column ads.

FIGS. 17A-B illustrate Company Administrator sign-on screens.

FIG. 17C is the listing of existing gallery ad Ad Masters for a Company that, in a preferred embodiment, is presented upon sign-on to a Company Administrator.

FIGS. 18A-B illustrate the required inputs when a Company Administrator creates a new Ad Master, in a preferred embodiment.

FIG. 19 is a listing of all Ad Masters that have been created for a Company that in a preferred embodiment is presented to a Company Administrator upon saving a newly created Ad Master in a Company and Publisher database.

FIG. 20 is an example of a screen used to originally specify the order of Ad Box components in an Ad Master for a gallery ad.

FIG. 21 is an example of a screen used to select Ad Boxes for inclusion as components of an Ad Master for a gallery ad.

FIGS. 22A-B show an example of a screen and drop-down list used to revise the ordering of Ad Boxes selected for inclusion as components of an Ad Master for a gallery ad.

FIGS. 23A-C show an example of a Filler Ad listing, the uploading of a Filler Ad, and the selection of a Filler Ad type from a drop down list, respectively, for a gallery ad.

FIGS. 24A-B illustrate Preview and Production Modes of viewing a completed Ad Master.

FIG. 25 illustrates a screen displaying a listing of Company Agents.

FIG. 26 illustrates a screen for input of information required to define a new Company Agent.

FIG. 27 illustrates a listing of Ad Masters submitted to a Publisher Super Administrator by a Company Administrator.

FIG. 28 illustrates a listing of the areas for which a Publisher PrePress Administrator has responsibility, for gallery ads.

FIG. 29 illustrates a listing of previously created Ad Master templates.

FIG. 30 illustrates the four tabs of the gallery ad Ad Master template creation screen for a non-limiting example of a Real Estate Company.

FIG. 31 illustrates a screen corresponding to the Measurement tab of an Ad Master template creation screen for gallery ads.

FIGS. 32A-B illustrate a screen and a drop down box corresponding to the Font tab of an Ad Master template creation screen for gallery ads.

FIG. 33 illustrates a screen corresponding to the Preview tab of an Ad Master template creation screen for gallery ads.

FIG. 34 illustrates a screen for input of Ad Deadlines for gallery ads.

FIGS. 35A-B illustrate screens for creating, editing and deleting Company information from the Company and Publisher database.

FIGS. 36A-B illustrate defining photo types.

FIG. 37 illustrates a business rule for associating photo types with a Company.

FIGS. 38A-B illustrate selection and upload of a Background Image file by a Publisher PrePress Administrator for gallery ads.

FIGS. 39A-C illustrate how Publisher PrePress personnel store Filler Ads and Bottom Filler Ads for gallery ads in a Company and Publisher database.

FIG. 39D is a list of Filler Ads showing type.

FIG. 40 illustrates a screen for defining personnel to fill a Super Administrator role for a gallery ad application.

FIG. 41 illustrates a screen used to edit locations of Company offices.

FIG. 42 illustrates a main menu screen for in-column ad Administration.

FIGS. 43A-C illustrate listings of in-column Ad Master templates for Automobile, Real Estate, and Employment ads.

FIGS. 44A-C illustrate “General” business rule information screens for both creating and editing in-column Ad Master templates for Automobile, Real Estate, and Employment ads.

FIGS. 45A-C illustrate “Fonts” business rule information screens for both creating and editing in-column Ad Master templates for Automobile, Real Estate, and Employment ads.

FIG. 46 illustrates a screen for setting publication deadline business rules for in-column ads.

FIGS. 47A-C illustrate setup of business rules for classified advertisement sections for Employment, Auto, and Home ads.

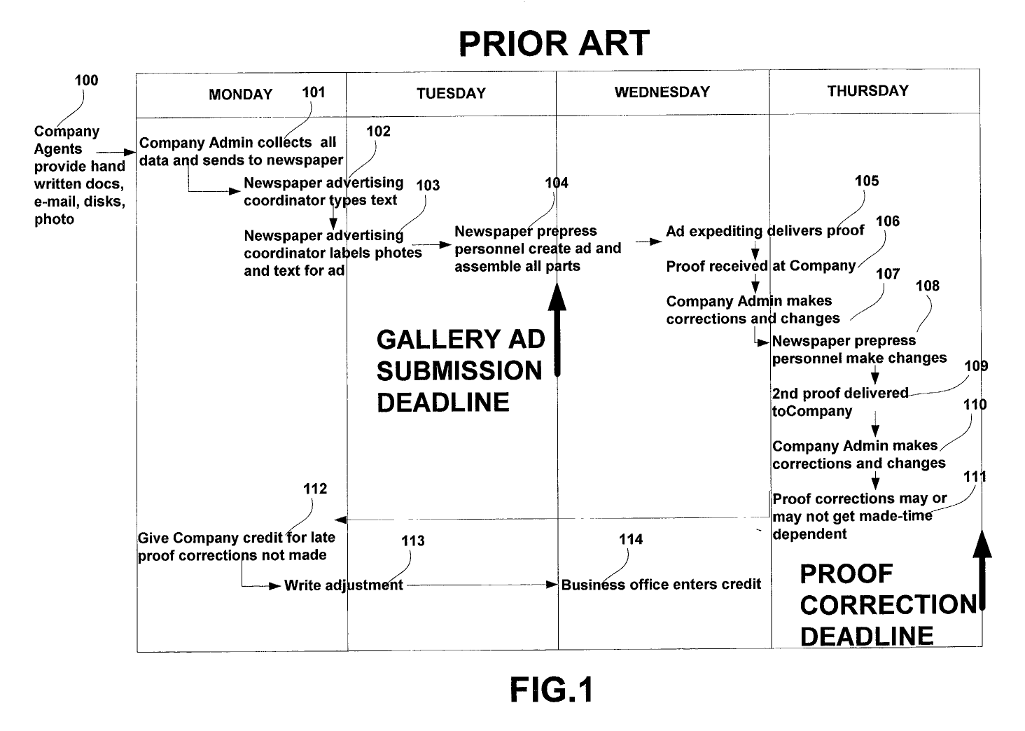

### DETAILED DESCRIPTION OF PREFERRED EMBODIMENTS

The present invention provides an interactive network-accessible computer-based system and method that provides administration and preparation support that spans the ad life cycle from initial Ad Box creation to Ad Master publication. The system and method of the present invention provide sales professionals a way to create, maintain, and control a significant aspect of their business electronic, print, and other media advertising.

The present invention allows sales professionals to create their own Ad Boxes on-line, edit them, extend deadlines for submission to Publishers, and maintain a private gallery of Ad Boxes in a Company and Publisher database 500 for reference, reuse and sharing.

The present invention allows Companies to control the ad creation process and coordinate Publisher acceptance of created ads using a network-accessible computer system and method that, in a preferred embodiment, is a Hosted system employing a networked, shared, replicated Company and Publisher database 500.

In the following discussion, preferred embodiments are sometimes presented in the context of a Real Estate gallery ad application or an Automobile Dealership in-column ad application. It should be understood that these examples are presented for illustrative purposes only and not in any limiting sense.

Method

Ad publication, regardless of type, requires preparation of ads by Company personnel and submission of ads to Publisher personnel who then oversee the ads through the Publisher's publication process. Several types of Company and Publisher personnel can be involved and, in a preferred embodiment, the system and method of the present invention provides for a flexible distribution of roles among Company and Publisher personnel. This distribution is accomplished by defining roles for Company and Publisher personnel. These roles are then reflected in their access privileges to a Company and Publisher database 500 and in the business rules restricting and defining their allowable data manipulation functions when using the system and method of the present invention.

For example, because there may be multiple Company Sales Agents creating ads, there can be any number of Company personnel assigned to this role with fewer Company Administrators overseeing all Company Sales Agents. It is up to the individual Company to determine what the scope of the Sales Agent's access will be, and, it may be limited to the presentation and manipulation of only the data that the individual Sales Agent has entered.

By contrast, in a Company with many organizational entities preparing ads, there may be a Company Administrator for each organizational entity for local approval of ads and then there may be a Company Super Administrator who has final say on all ads to be published. Alternatively, in a Company with autonomous Sales Agents, there may be only Company Sales Agents and no Company Administrators or Super Administrators who approve ads. Similar flexibility in determining roles for Publisher personnel is provided in a preferred embodiment of the system and method of the present invention, and there may even be no role for Publisher personnel in an alternative embodiment of the current invention.

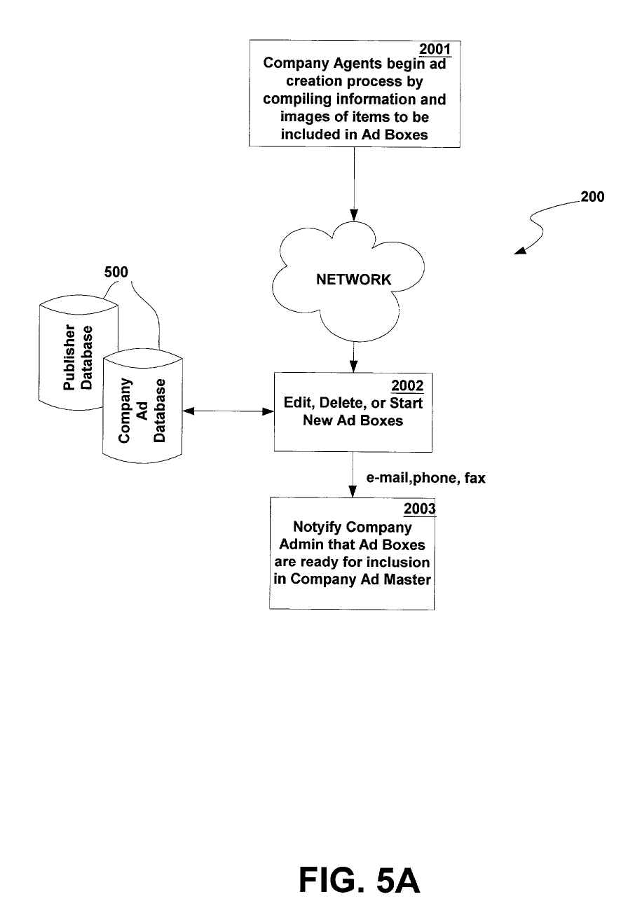

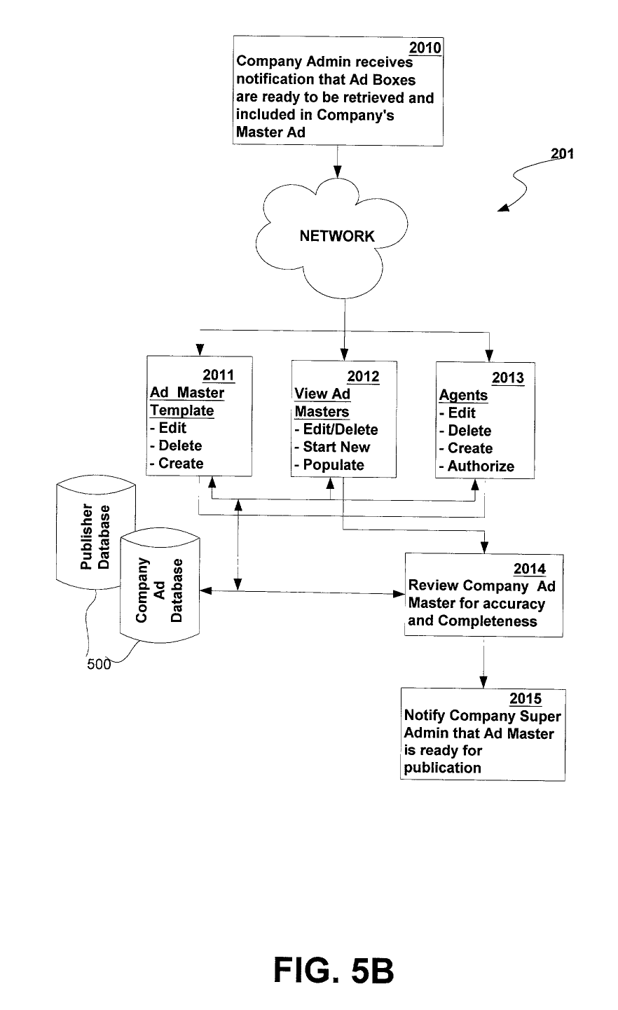

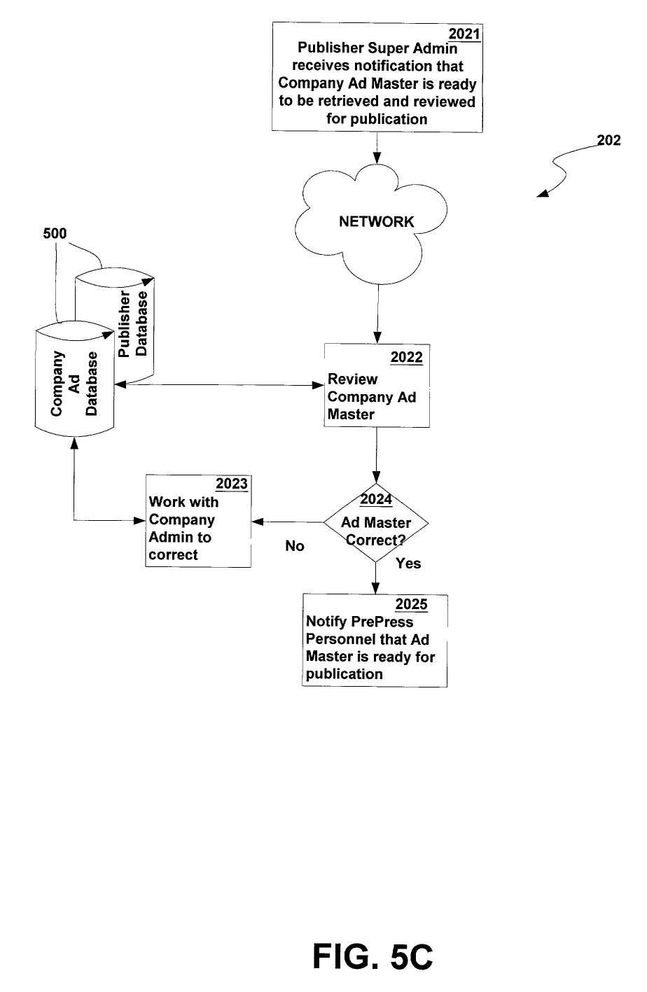

Ads can be as simple as single in-column Ad Boxes or a matrix of N×M Ad Boxes, known as a gallery ad. To a certain extent, the roles established for the Company personnel depend on the types of ads being prepared. In a preferred embodiment for a Company preparing gallery ads for publication, as illustrated in FIGS. 5A-5C, two types of Company personnel are involved in the production of a Company's gallery ads. First, as illustrated in FIG. 5A, there is the Company Sales Agent (hereinafter Company Agent) who lists items being offered and creates the individual item entries in a gallery ad, i.e., creates the Ad Boxes 2002, to be placed into one or more of a Company's gallery Ad Masters by a Company Administrator 2003. Second, there is the Company Administrator who lays out the Company's gallery ads. The Company Administrator, as illustrated in FIG. 5B, is responsible for selecting an Ad Master template 200 to be optionally customized 2012 and then populated with specific Ad Boxes created by individual Company Agents 201. The Company Administrator enters Ad Boxes as components of an empty Company Ad Master created from a Company Ad Master template and adds and removes Ad Box components from previously composed Company gallery Ad Masters. The Company Administrator also enters filler ads for those gallery Ad Masters that result in empty boxes, e.g., insufficient Ad Boxes to fill the entire Ad Master.

In a preferred embodiment for gallery ads, Company Sales Agents and Company Administrator(s) cooperate to produce a Company's gallery Ad Masters. That is, Company Agents create original Ad Boxes or edit existing Ad Boxes to create entries for the Company's current gallery Ad Masters 2002. Then, Company Administrators lay out one or more gallery Ad Masters by choosing an Ad Master template 2011 for each gallery ad from a Company and Publisher database 500. The chosen Ad Master template is used to create an instance which is optionally customized and then populated with components using the Ad Boxes which have already been composed by Company Sales Agents 2012.

Once approved Company Ad Masters have been laid out by Company Administrators, in a preferred embodiment, each is submitted 2015 to Publisher Super Administrator personnel. The Publisher Super Administrator personnel review and correct 2022 and then submit each “camera ready” gallery ad to Publisher PrePress Administrator personnel for publication 2025. Then, the Publisher PrePress Administrator personnel add background image components and otherwise prepare the final gallery ad Ad Master instance and the Ad Master instance enters the Publisher's publication process.

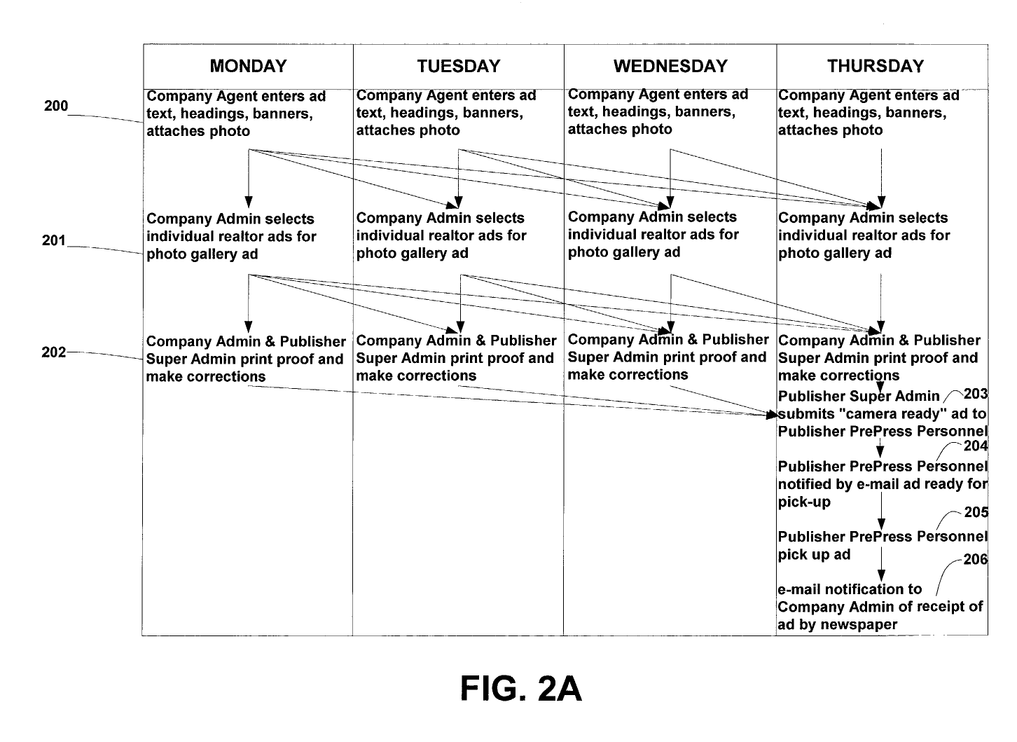

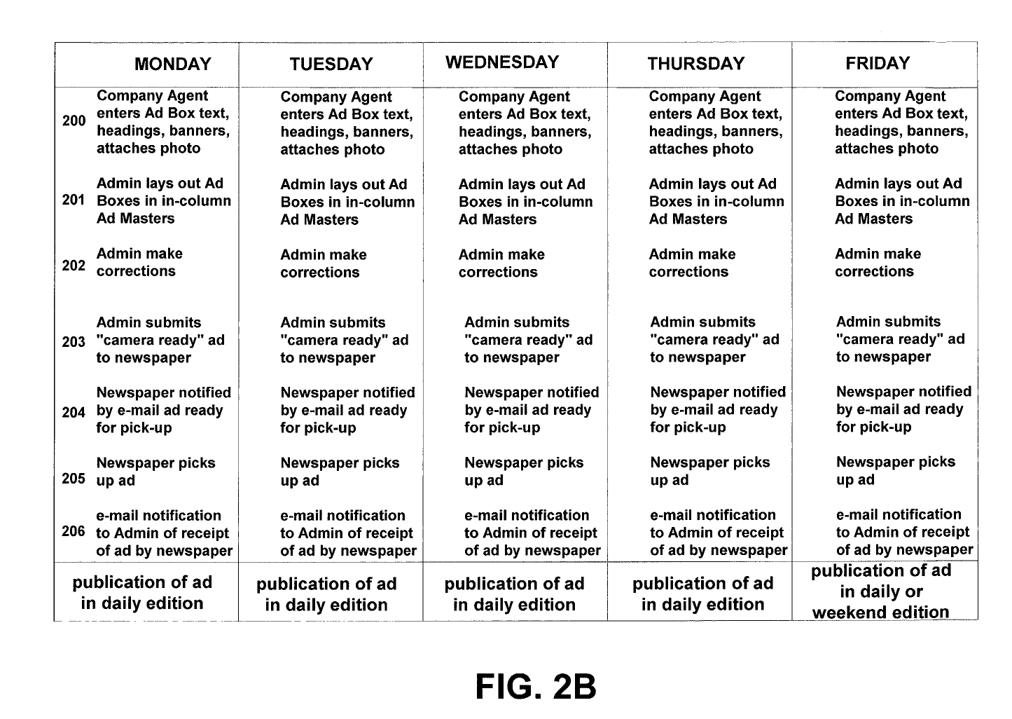

In an embodiment for in-column ads, as illustrated in FIG. 2B, there are only two types of personnel who fulfill all roles, namely, the Company Sales Agent and an Administrator. In this embodiment, the Administrator sets up Ad Master templates that incorporate both Company and Publisher business rules.

In alternative embodiments, the distribution of roles and responsibilities is dependent on the organizational structure of both the Company placing ads for publication with a Publisher and the publication publishing these ads.

Database

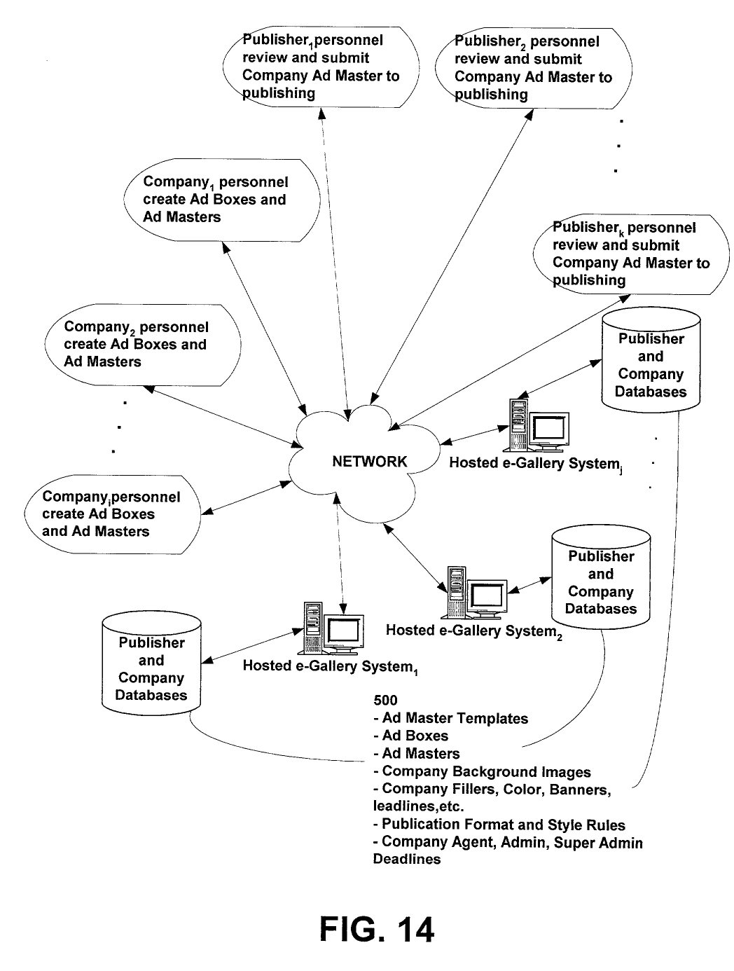

In a preferred embodiment of the present invention, a Company and Publisher database 500 is provided for persistent storage of all the data and templates associated with an embodiment of the present invention. For example, for gallery ads there will be stored one or more Ad Box and Ad Master templates embodying Company and Publisher business rules. Also stored are Company Agents' private Ad Boxes, Filler Boxes and Bottom Filler Boxes, lead lines, etc., in-process gallery Ad Masters, composed Ad Masters, published gallery Ad Masters, and ancillary information. In a preferred embodiment, the Company and Publisher database 500 is network-accessible and is a replicated distributed data resource shared by Companies and Publishers, as illustrated in FIG. 14. Each role established for Company and Publisher personnel is reflected in access privileges to both the data stored in this Company and Publisher database 500 and the functions for manipulating this stored data.

Security and Administration

A hierarchy of the Company and Publisher personnel roles (e.g., Sales Agent, Administrator, Super Administrator, and PrePress Personnel) is formed from user classes, in a preferred embodiment, which allow access control and administration of a Company and Publisher database 500. For example, a Sales Agent may be limited to accessing only those Ad Boxes composed by that Sales Agent and updating only newly entered (IN WORK) Ad Boxes. The Sales Agent's view of a composed Ad Master may be limited to that Sales Agent's Ad Boxes as they appear in an Ad Master, as well. In a preferred embodiment, depending on the ad type, already composed Ad Masters are saved in the Company and Publisher database 500 for a pre-specified number of days before being purged from the Company and Publisher database 500. In an alternative embodiment, Ad Masters can be archived for a longer period of time to allow longitudinal studies of trends, e.g., data mining. A business rule associated with the corresponding Ad Master template determines the retention period for a given Ad Master.

In an alternative preferred embodiment for in-column ads, Ad Masters run for selected days and when the ad run period has expired the Ad Master is deleted from the database and must be created again, entry-by-entry, as a new Ad Box. This new Ad Box will then be published as an Ad Master corresponding to the then current active Ad Master template.

This flexibility of retention and archiving is implemented by business rules stored in the Company and Publisher database 500, and extends to all functions and data structures of the present invention for each ad type.

Schema

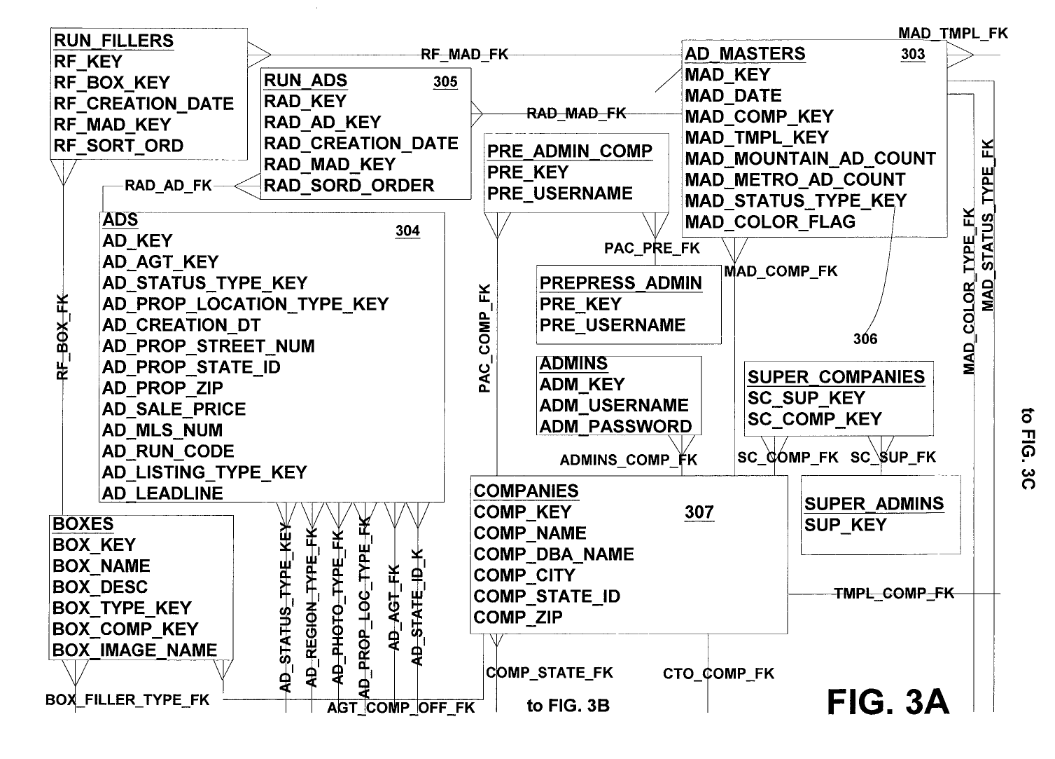

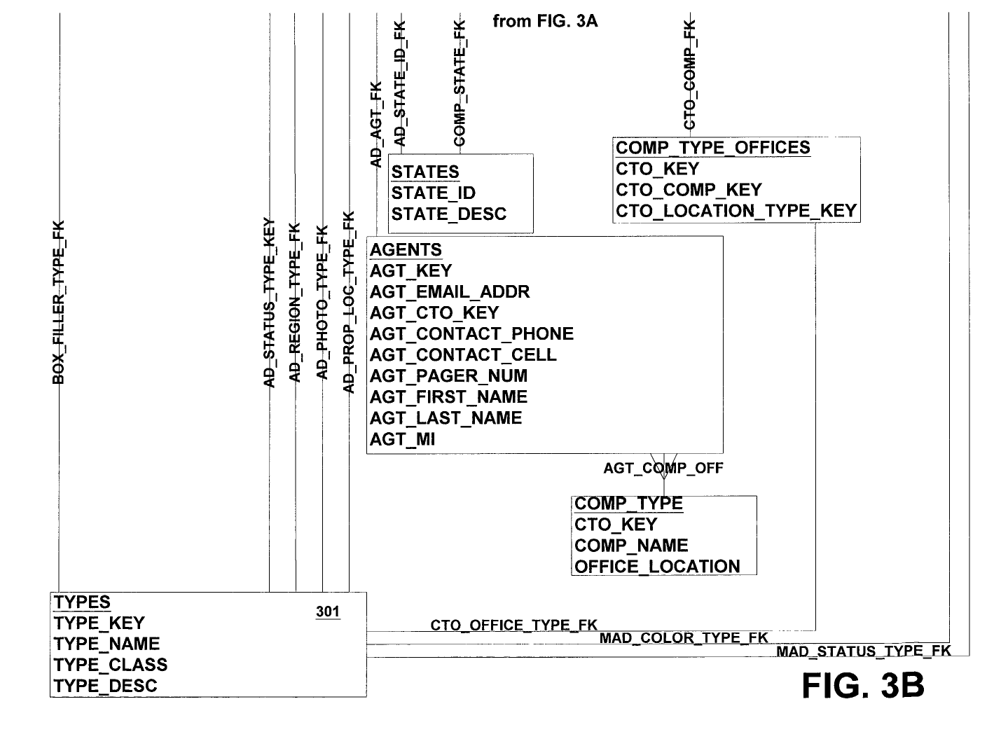

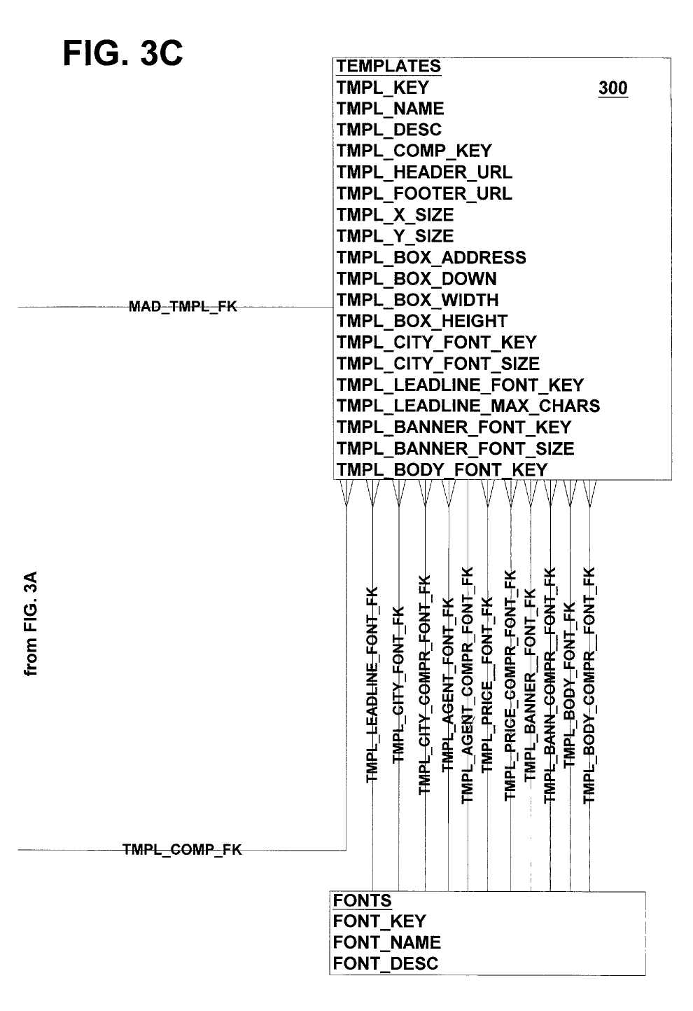

A portion of a Company and Publisher database schema in a preferred embodiment of a Company and Publisher database 500 is illustrated in FIGS. 3A-3C. In addition to completed Ad Masters, their component Ad Boxes, and underlying Ad Master templates, in a preferred embodiment, Ad Masters under construction are also stored in the AD_MASTERS table 303 and related by the RUN_ADS table 305 to component Ad Boxes stored in the ADS table 304. Each stage of the processing of an under-construction Ad Master is reflected by a status entry MAD_STATUS_TYPE_KEY 306 stored in the database table AD_MASTERS 303 and defined in the TYPES database table 301.

In a preferred embodiment, an Administrator establishes the characteristics of each Company's Ad Masters and their component Ad Boxes that appear in a Publisher's publication(s) by defining Ad Master templates and default Ad Box characteristics in database table TEMPLATES 300. For example, for each publication font styles and sizes are specified and stored by an Administrator in the FONTS 302 and TEMPLATES 300 tables. In this way, each Publisher can establish and maintain its own style by enforcing style and format business rules at the time of Ad Box creation and Ad Master layout by Company personnel.

Other types of ads may have different standards imposed by associating business rules with their Ad Master templates.

The Ad Box is the fundamental ad building block of the present invention. Every ad created using the system and method of the present invention is built using one or more Ad Boxes and Ad Boxes can vary in type and format. In a preferred embodiment, every Ad Master is based on an Ad Master template stored in the TEMPLATES 300 table. An Ad Master template comprises an arrangement of at least one component Ad Box. In general, each Ad Master template in the TEMPLATES 300 table defines vertical and horizontal spacing for component Ad Boxes as well as the number of vertical and horizontal Ad Boxes it can contain. For Ad Master templates containing more than a single Ad Box, Ad Box ordering is also defined in the Ad Master template.

A printed page, an electronic ad page, a billboard ad, a movie theatre screen ad, and even a radio ad can each be composed and their contents ordered using the Ad Box and Ad Master paradigm of the present invention and therefore can be composed and administered using the system and method of the present invention. As a non-limiting example, Ad Box components of a gallery ad embodiment for a Real Estate Company can be sorted by City and Sales Price, Multiple Listing Service (MLS) Number, Region or Sales Price. In addition a Custom Sort option allows virtually any sort order to be manually specified for the component Ad Boxes.

In a preferred embodiment, as already stated, each publication can have a style it imposes on the format of an Ad Master by means of certain database entries in the TEMPLATES table 300. For example, a font can be established by a print media Publisher as the default or regular font for each Company submitting laid out Ad Masters for publication. As an example of a Publisher-specific rule, whenever the default font is too large to accommodate a text entry being entered into an Ad Box, a compressed font can be substituted and the text for the Ad Box is then resized. Default fonts for each line of an Ad Box are maintained in the Company and Publisher database 500 in the TEMPLATES table.

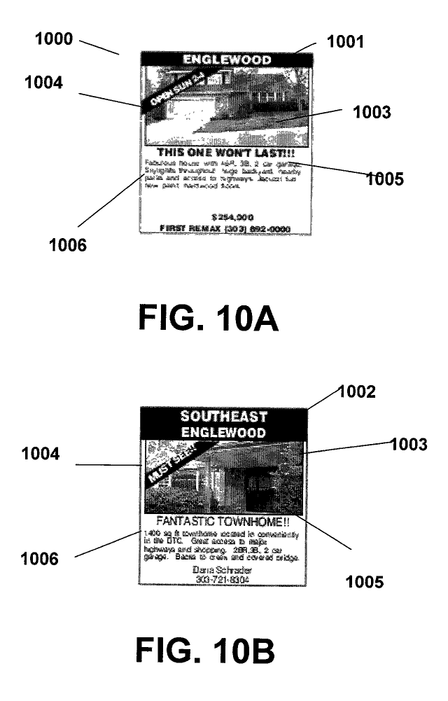

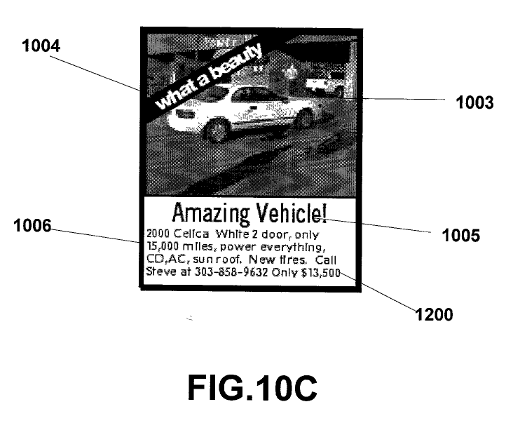

In a preferred embodiment, some of the entries in an Ad Box can be required and some can be optional. Using a Real Estate Company print ad as a non-limiting example, FIGS. 10A and 10B illustrate that in a preferred embodiment, an individual Ad Box comprises several entries at certain line locations relative to the top of an Ad Box. The particular needs of the Company placing the Real Estate ad determine the required and optional entries. Further, an Administrator establishes the Company and Publisher database 500 entries that control the characteristics of these required and optional entries in order to ensure that ads are consistent with the established styles of publications.

Required Entries—In a preferred embodiment, an Administrator is able to specify that certain entries in an Ad Box are required. In a Real Estate Company ad, as a non-limiting example, there are typically several required entries for each Ad Box, as illustrated in FIGS. 10A-B. Among them are geographic location display 1000, image 1003, and lead lines 1005. The required entries vary depending on the type of items being offered for sale by Company and on the media in which the ad will be displayed.

As a non-limiting example for a Real Estate Company print ad, the first line(s) of an Ad Box are entries corresponding to the geographic location display 1000 that consists of a single city line 1001 or a two line Region and City entry 1002. In a preferred embodiment, the Region is pre-defined in the database table TYPES 301 and is always the first line of a two line geographic location. The font and maximum amount of text in the entry for the geographic location lines are defined by the business rules associated with the default template in the database table TEMPLATES 300. In an alternative embodiment for a Real Estate ad, geographic location data is white on black, for emphasis. This example applies to Ad Boxes for both gallery and in-column print ads for a Real Estate Company.

As a further non-limiting example, FIG. 10C illustrates a preferred embodiment of an in-column print ad for an Automobile Dealership. The required Ad Box entries include Classification (type of ad), Make, Model, Year and Price, and not all these entries will appear in the published in-column ad. In a preferred embodiment, depending on the ad type, image entries can include animation, audio, film clips, drawings, photographs, etc., of items for sale 1003, e.g., a photograph of a property or a video tour of a property. Image entries are intended to appear following the first required lines (e.g., geographic location line(s) for a Real Estate Company). For example, digitized images intended for print media have dynamic horizontal and vertical image sizes that are defined by a business rule in terms of pixels in the database table TEMPLATES 300. While any type of image entry can be accepted for print ads, in a preferred embodiment, digitized image entries in jpeg and bmp formats are the most common types. In an alternative embodiment, jpeg image entries can be either Grayscale or RGB.

In a preferred embodiment for an Automobile Dealership in-column print ad, immediately following the image entry is the lead line or Sig line 1005, whose font style and size (and therefore length) are defined by a business rule associated with the default template in the database table TEMPLATES 300. In an alternative embodiment, a business rule can be implemented so that the lead line or Sig line 1005 appears only in black text on a white background.

Next in an Ad Box for an Automobile Dealership in-column print ad, the ad body text entry 1006 appears. However, the position of the ad body text entry can be varied by type of print ad. The size of the text for the body entry depends on the font required by the associated business rule and the amount of text supplied. A default font and size are provided as business rules in the database table TEMPLATES 300. Adjustments are made automatically to accommodate the text entry, by decreasing the font size in steps of 1 until either the text fits in the Ad Box or a lower limit on the font size is encountered. If the body text entry still does not fit, then COMPRESSED FONT is used. In a preferred embodiment, for print media a font size of 6 is the lower limit and if the body text entry still does not fit using compressed font at the lower limit, then an “ad submission” error is issued.

Optional Entries—In a preferred embodiment, the Administrator is able to designate certain Ad Box entries as optional. For example, for gallery and in-column print ads, optional entries include banner 1004, Company data 1100, and dollar amount 1200 display entries. Banners entries 1004 are optionally provided in the image area to allow a Company to emphasize some special feature of the item that is the subject of the Ad Box. Banner entries 1004 can be optionally placed in any position in the image, and in a non-limiting Real Estate Company example are in the upper left hand corner of the image and are white text on a black background, and are at an angle to the image. The angle of the banner entry 1004 with respect to the top of the Ad Box is 45 degrees. Banner entry 1004 font style and size as well as Ad Box width and height are each determined by business rules entered by an Administrator and associated with a template in the database table TEMPLATES 300.

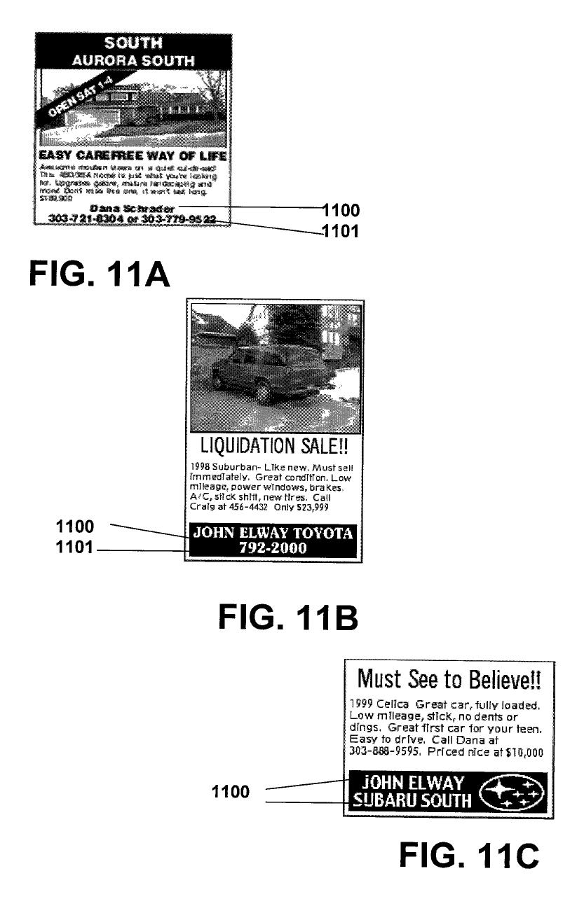

Company data display or logo entry 1100 is another option, in a preferred embodiment for gallery and in-column print ads. One alternative embodiment provides a business rule, in the template stored in the database table TEMPLATES 300, for an entry corresponding to the Company name and telephone number so that they appear on the same line. In another alternative embodiment, a second business rule in the template allows for the option of two lines of Company data, as illustrated in FIG. 11B. For example, as illustrated in the non-limiting examples of FIG. 11A-B, the first Company data display or logo line 1100 can be the Company name and the second line can be the Company telephone numbers 1101. Alternatively, the second line can be a continuation of the Company name 1100, as illustrated for an Automobile Dealership Company in FIG. 11C.

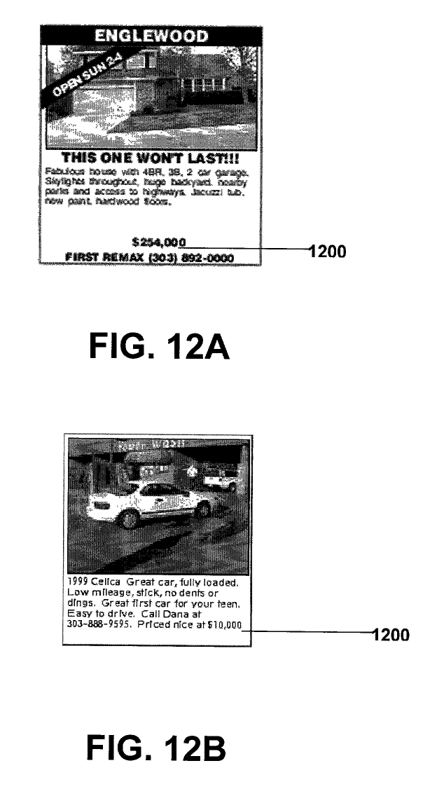

An entry for dollar amount display is another option, in a preferred embodiment. In one alternative embodiment, a business rules is provided so that individual Ad Box instances within a gallery ad Ad Master instance for a Company, either all display a dollar amount or all do not. The system and method of the present invention can incorporate this kind of consistency among Ad Box entries of a given Ad Master and this feature is controlled by the business rules associated with the Ad Master template being used. In a preferred embodiment, the database table TEMPLATES 300 contains Ad Master templates that have business rules that can be set and reset, such as inclusion of options and consistency of options across all Ad Boxes. Once these business rules are set, in a preferred embodiment, they are enforced for all Ad Boxes in an Ad Master using a given Ad Master template. In addition, the database table TEMPLATES 300 maintains dollar amount fonts. In a non-limiting Real Estate Company example, the dollar amount entry is Price 1200 and is positioned as illustrated in FIG. 12A below the body entry and centered. For an in-column ad, the price can alternatively be included in the ad text entry, as illustrated in FIG. 12B.

In a preferred embodiment, regardless of ad type, once an individual Ad Box has been released by the Company Sales Agent, the status of the Ad Box is changed by the system and method of the present invention to IN USE. If an Ad Box is IN USE it cannot be opened or edited by the Company Sales Agent who originated it. After the laid out Ad Master has been sent to the Publisher, it will be LOCKED, meaning that it cannot be edited or deleted. The Ad Box will be available for editing and deletion after the Ad Master is sent to print. A copy of the IN USE or LOCKED Ad Box can be made, however.

In a preferred embodiment, an Ad Box can be a component of many different Ad Masters and its appearance can differ in each Ad Master. As a non-limiting example, an Ad Box may appear differently from one gallery ad to another, e.g., one with a price and one without, one with an agent name and one without, etc. Therefore, a preferred embodiment provides one default Ad Box template for displaying an individual Ad Box for editing and review purposes and all the components associated with an Ad Box are presented for review.

Ad Master

An Ad Master template is a layout and format template that captures both Company and Publisher rules and enforces these rules each time an Ad Master instance is created and edited. An Ad Master template can correspond to a gallery ad or an in-column ad in a newspaper or other print media. An Ad Master template can also represent ad space in Web pages and other electronic media. An Ad Master template can also capture formatting rules for movie theatre screen ads, television and radio ads.

According to a preferred embodiment of the present invention, an ad is prepared for publication by establishing format and business rules for the ad using an Ad Master template stored in the database table TEMPLATES 300. The database table TEMPLATES 300 is populated with templates and an Ad Master can only be composed using a template that already exists in the TEMPLATES 300 table. However, Ad Master templates may be revised, added and deleted at any time.

In a preferred embodiment for Real Estate gallery ads, Publisher PrePress Administrator personnel set the characteristics of Ad Master templates to enforce the publication's style in each ad composed using these templates. In this preferred embodiment, required Ad Master template information includes general information and measurement information. General information includes template, name, description, default Ad Box template, company, show datal, show dollar amount, show two Company lines, crop image, show data2. Measurement information in a preferred embodiment is in pixels and is set for the overall Ad Master, individual images, individual Ad Boxes, and spacing in between these components.

Each Company can have one and only one default Ad Box template, in a preferred embodiment. This default template determines how Ad Boxes are viewed, reviewed, and populated by Company Sales Agents. In a preferred embodiment, the default Ad Box size is approximately 2×2 inches. In an alternative embodiment, a plurality of formats can be provided for displaying Ad Boxes.

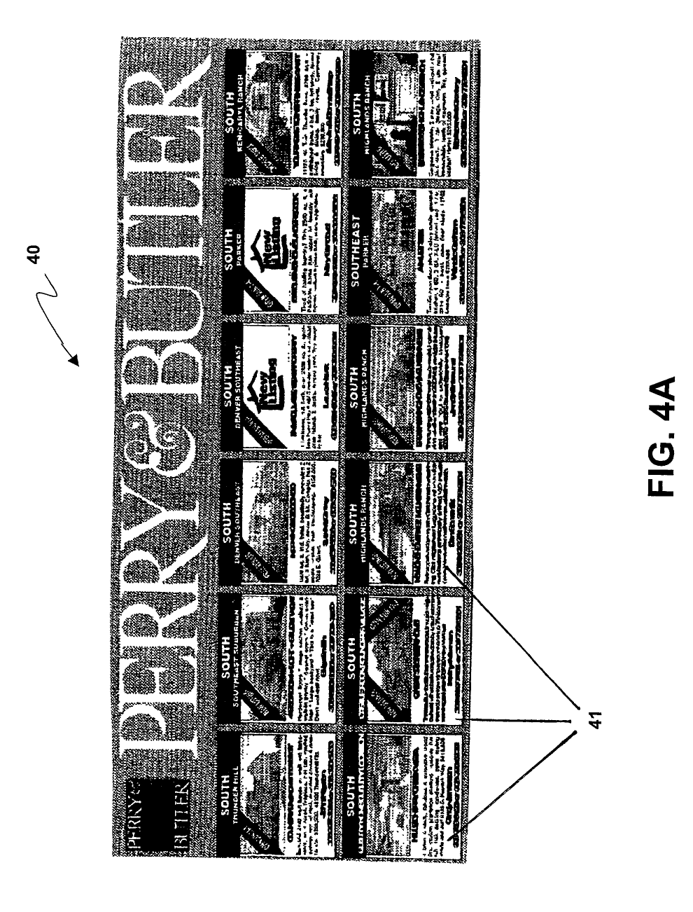

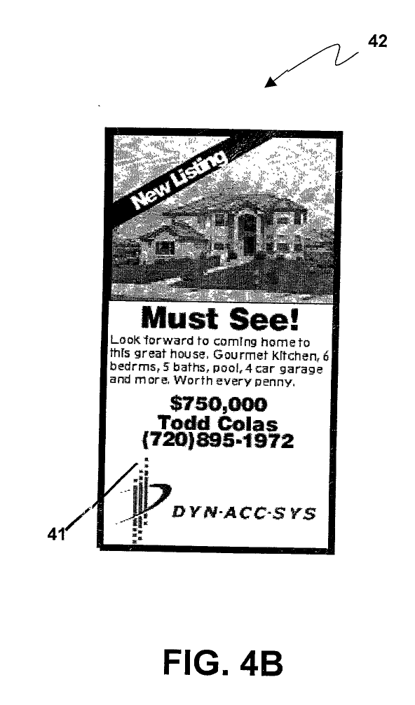

A business rule controlling color is also associated with an Ad Master template and, in a preferred embodiment, can include Spot (black and white ads, color background image), black and white or color. Background images are for the overall ad and must correspond in size with the size of the Ad Master they are associated with. That is, the background image width and height is limited to the size of an Ad Master as defined in its associated Ad Master template by the Prepress Ad Administrator personnel. In FIG. 4 the background image 40 includes the name of the Real Estate Company and the fill in-between the Ad Boxes

In a preferred embodiment, the status an Ad Master can assume is an example of the administrative business rules that can be applied via Ad Master templates. For gallery and in-column print ads this status includes, but is not limited to:

| | |
|---|---|
| IN WORK | being created or edited |
| REOPENED BY PRESS | sent back for revision |
| SENT TO PRINT | sent to be published |
| SEND TO PUBLISHER | ready to be sent to a Publisher |
| ARCHIVED | already published |

These status types are stored in the database TYPES 301 table and are completely dependent on the Company and Publisher preferences at the initial implementation of an embodiment of the system and method of the present invention and can be revised at any subsequent time, as the need arises. The MAD_STATUS_TYPE_KEY 306 entry in the AD_MASTERS 303 table identifies the corresponding status type stored in the TYPE 301 table. The status of an Ad Master indicates its life cycle stage, i.e., the stage of processing it is undergoing.

For example, for gallery ads the first time an Ad Master is created as an instance of an existing Ad Master template, it is considered to be in IN WORK status. Thereafter, Ad Masters can only be deleted in the IN WORK status. Once an Ad Master is released to the press, the Ad Master goes into SEND TO PUBLISHER status. Thereafter the Ad Master cannot be modified unless its status is changed to REOPENED BY PRESS. Once the Ad Master is sent to press, the Ad Master will be in SENT TO PRINT status. In a preferred embodiment, a business rule is provided so that once a predetermined number of days have elapsed after the Ad Master has been published, the ad will achieve the ARCHIVED status.

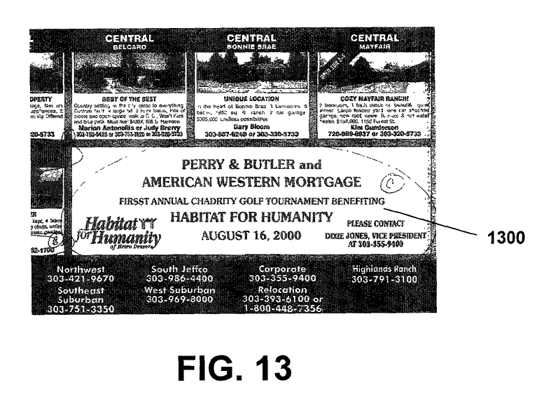

In a preferred embodiment, the bottom row of a gallery ad can include a Bottom Filler Ad or Filler Ad1300, as illustrated in a non-limiting example for a Real Estate Company gallery ad in FIG. 13. The number of Ad Boxes in a Bottom Filler Ad is determined by a business rule associated with the Ad Master during its setup as an Ad Master by the Company Administrator. A three box Bottom Filler Ad 1300 is shown in FIG. 13 for a non-limiting example of a Real Estate Company gallery ad. In a preferred embodiment, Bottom Filler Ads range in size between two boxes and five boxes but cannot exceed the maximum number of horizontal boxes for the Ad Master template selected. In a preferred embodiment, Bottom Filler Ads must be in jpeg format.

Company Ad Masters represent instances of Ad Master templates that have been filled-in with components, i.e., which have been populated with time-sensitive Ad Boxes for specific items being offered and Filler Ads to fill in empty spaces. Ad Masters, therefore, are perishable and need to be purged from the Company and Publisher database 500. In a preferred embodiment, each Ad Master is marked to be purged a set number of days after publication, with the number of days determined by a business rule associated with the corresponding Ad Master Template used to create the published Ad Master. For example, in-column ads are purged immediately following their final publication date.

In a preferred embodiment, in-column ads are associated with the Ad Master template that was active at the time the in-column Ad Box was created. In-column ads are limited to a single component Ad Box and published font, image size, width and height, of the single component Ad Box are each determined by a business rule associated with the corresponding Ad Master template

The characteristics of published ads of other types are also controlled by the business rules associated with the Ad Master template on which the published ad is based.

Companies

In a preferred embodiment for gallery ads, Companies are set up in the Company and Publisher database 500 by PrePress Administrator personnel. Each Company has sales professionals that create Ad Boxes for items being offered, i.e., they are Company Agents. Each Company may also have one or more Administrator personnel who are responsible for setting up and administering the ad system of the present invention for the Company, including laying out Ad Masters and populating them with components such as Ad Boxes created by Company Agents. Company Ad Masters are approved for publication by Super Administrator personnel, who work with Administrators to correct any deficiencies noted in a Company Ad Master under preparation for publication.

In alternative preferred embodiments, the roles may vary both in number and function depending on the ad type, e.g., these four roles are defined for gallery ads but only a Company Agent role and an Administrator role are defined for in-column ads.

Image Entry Types

Image entries can include digitized photographs, drawings, film clips, animation, video tours, etc., and accompanying audio. Each Publisher has the option of specifying a preferred format. In a preferred embodiment for gallery ads, PrePress Administrator personnel set up the allowable image entry types and associate one or more of these allowable types with each Company. In a preferred embodiment, photographs must be in jpeg format.

Similarly, for in-column ads, an Administrator sets up the allowable image entry types for each Company.

The setup of image entries can be assigned to any valid role.

Ad Deadlines

In a preferred embodiment, each Publisher has the option of specifying business rules governing deadlines for submissions by personnel fulfilling the defined roles, e.g., Company Agents, Administrators, and Super Administrator personnel. In a preferred embodiment for gallery ads, a publication's PrePress Administrator personnel establish and maintain these business rules for deadlines in the Company and Publisher database 500 for each Company publishing ads in the Publisher's publication.

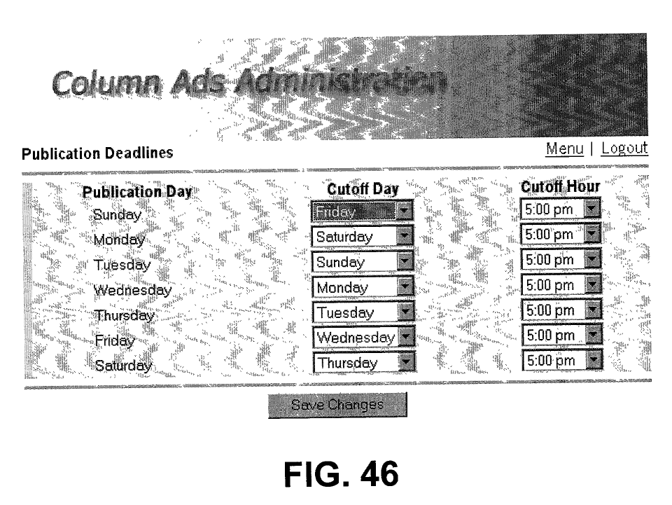

In an alternative embodiment, any one of the defined roles can be responsible for setting deadlines in the Company and Publisher database 500, and in a preferred embodiment for in-column ads these deadlines are established by an Administrator using a screen such as the one illustrated in FIG. 46.

PDF Files

In a preferred embodiment for gallery and in-column ads, PDF is the format for the exchange of Ad Masters between a Company and a Publisher. Two modes are available for viewing a PDF Ad Master: Preview Mode and Production Mode. Preview Mode is only available for those Ad Masters corresponding to Ad Master templates for which this mode has been in the Company and Publisher database 500.

A business rule determines the format for this exchange and any valid format can be employed.

E-Mail Confirmation Messages

In a preferred embodiment, e-mail messages are automatically sent between personnel assigned to the various roles when a business rule determines that such an e-mail messages is to be sent, e.g., when the status of an Ad Master changes in the Company and Publisher database 500. For example, in a preferred embodiment for gallery ads, upon completion of laying out a gallery Ad Master by a Company Administrator, a Publisher Super Administrator is automatically sent an e-mail message that the gallery Ad Master is ready for review. When a Publisher Super Administrator retrieves the gallery Ad Master for review, a Company Administrator is automatically sent an e-mail message stating that the gallery Ad Master has been retrieved for review by a Publisher Super Administrator.

In a different distribution of roles among Company and Publisher personnel, these messages would be exchanged between the personnel fulfilling these roles as required by the business rules of the Company and Publisher implementing the system and method of the present invention.

Roles

In a preferred embodiment, there can any number of Company roles and Publisher roles and these roles have corresponding Company and Publisher database 500 access privileges afforded to them. For example, a Company Agent is only able to view and work on Ad Boxes created by that Company Agent. A Company Administrator can view all Ad Boxes created by all Company Agents and can view all of the Company's Ad Masters and Ad Master templates. However, a Company Administrator cannot change Publisher-specific business rules associated with Ad Masters or Ad Master templates. A Publisher Super Administrator can view the same database records as a Company Administrator but has sole privilege to change Publisher-specific business rules and to change the status of an Ad Master to SEND TO PRINT, among other privileges for data access and data manipulation capabilities.

The roles defined for a particular embodiment of the present invention can also be delegated to a third party, e.g., a contractor responsible to either the Company, Publisher or both. The roles are intended to operationalize an agreed upon administrative process, between a Company and Publisher. These roles support Companies in the capture of ad details, ad approval and billing and in imposing style and deadlines. Data and business rules are part of a Company and Publisher database 500 for which all roles have pre-defined access privileges for realizing the advertising objectives of both a Company and Publisher. These roles and rules are flexible and can be revised and reassigned at any time, in a preferred embodiment, and need not be assigned to employees but can be assigned to contractors.

In a preferred embodiment for gallery ads, a second type of Publisher personnel, the Publisher PrePress Personnel, sets up the Ad Master templates for each Company and Publisher. The Publisher PrePress Personnel specify both business rules for both the Company rules and particular publication style by entering fonts, font sizes, and other publication specific rules for the format and layout of ads that are to be published by the Publisher in its publications.

In an alternative embodiment, the distribution of roles within a Company and Publisher and between a Company and a Publisher is determined at the time of installation of the system and method of the present invention and can even be modified thereafter, as needs evolve.

Agent Role

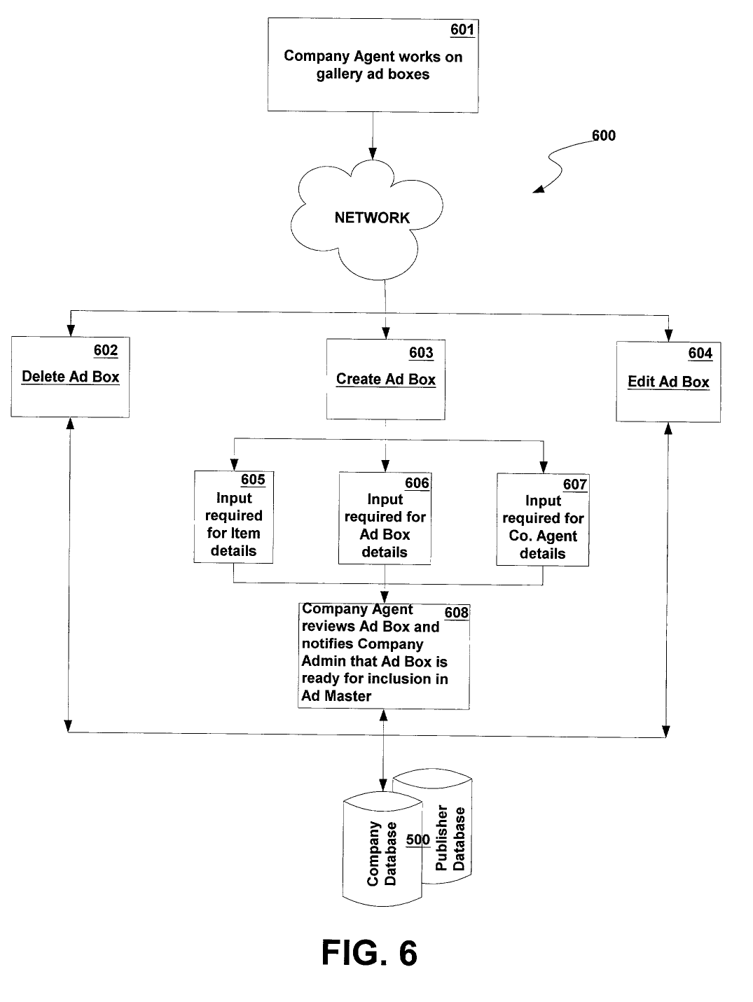

In a preferred embodiment, each Company assigns a plurality of its personnel to perform the role of Company Sales Agent in the system and method of the present invention. Each Company Sales Agent is authorized to create, edit and delete Ad Boxes and can have a Private Gallery of Ad Boxes. Ad Boxes offer items to potential consumers and contain sufficient item details for a potential consumer to make an informed selection from an ad containing one or more Ad Boxes. FIG. 6 illustrates how a Company Agent works on Ad Boxes 601, in a preferred embodiment. The Company Agent accesses a Hosted embodiment of the system of the present invention via a network, which is accomplished using a Web browser to access the Host over the Internet, in a preferred embodiment.

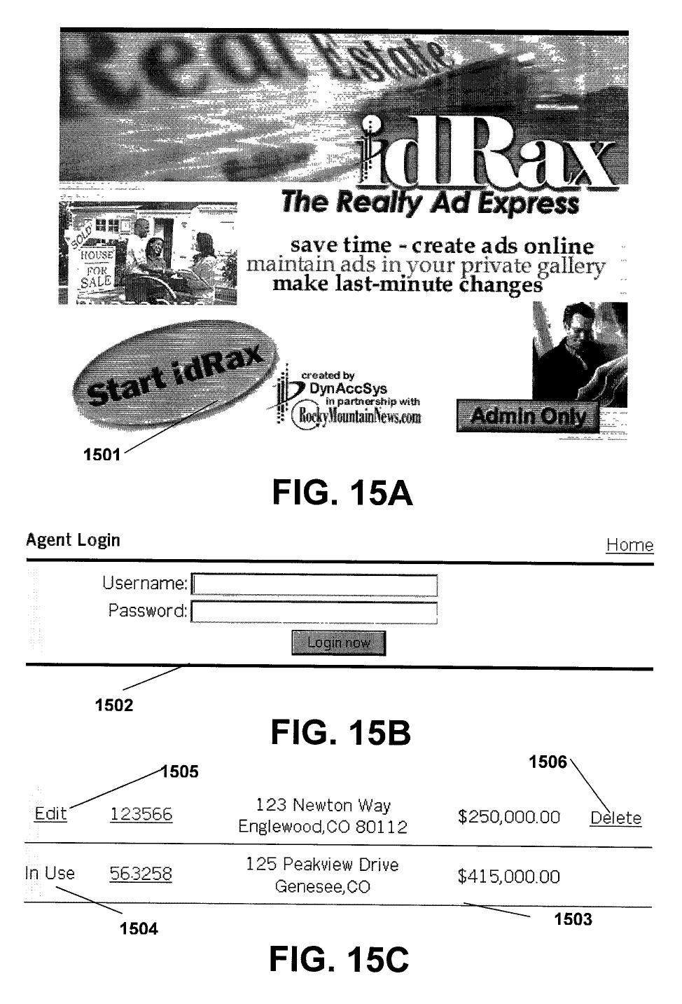

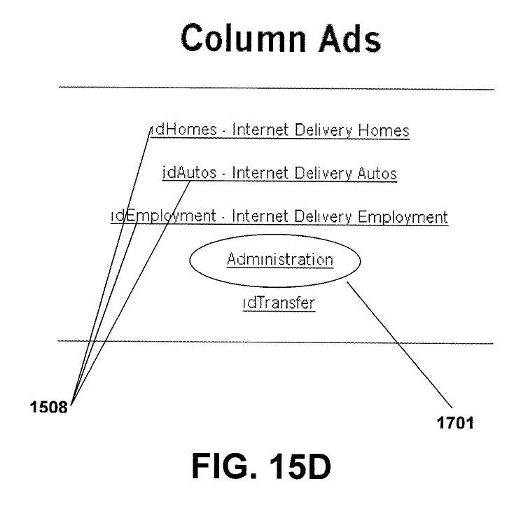

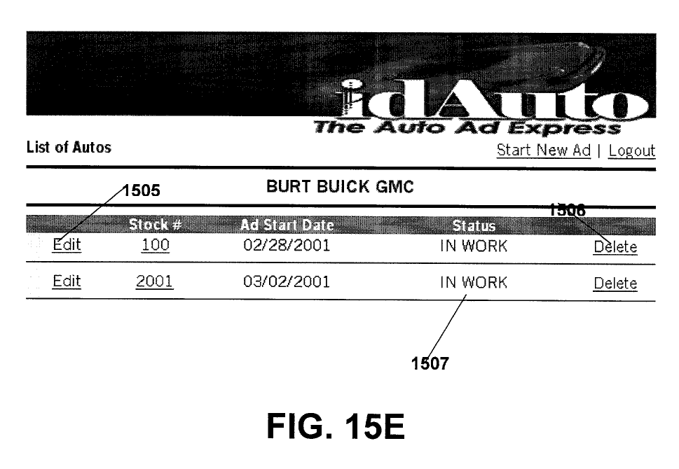

Gallery Ad Embodiment—On initial access, a Company Agent is presented with a home page screen, such as the one for a non-limiting example of a Real Estate Company home page, illustrated in FIG. 15A. After selecting “Start” 1501, the Company Agent is presented with the logon dialog box 1502, shown in FIG. 15B, and if logon is successful, the Company Agent's private gallery of Ad Boxes is listed 1503, as illustrated in FIG. 15C.

At this point, the Company Agent may choose to delete 602, create 603, or edit 605 an Ad Box in the Company Agent's private Ad Box gallery. As shown in FIG. 15C, delete and edit functionality are accessed directly from the listing of the Company Agent's private gallery contents. Clicking on the Edit button 1505 causes an Edit Ad screen to be displayed for the corresponding Ad Box in the Company Agent's private gallery and clicking on the Delete button 1506 causes a Delete confirmation dialog box to be displayed. However, if the Ad Box has been selected by the Company Administrator for inclusion is the current week's Ad Master, then In Use appears in place of the Edit button, there is no Delete button, and the Company Agent is not able to select the corresponding Ad Box for deleting or editing until after the current weekly cycle for submission of gallery ads to the Publisher. After submission, the Company Administrator releases all Ad Boxes and the Agent's Ad Boxes can, once again, be edited and reused, or deleted.

In a preferred embodiment, when a new Ad Box is to be created three classes of information must be supplied by the Company Agent: item details 605, Ad Box details 606, and ad type details 607, where ad type details are Company Agent information for a gallery ad.

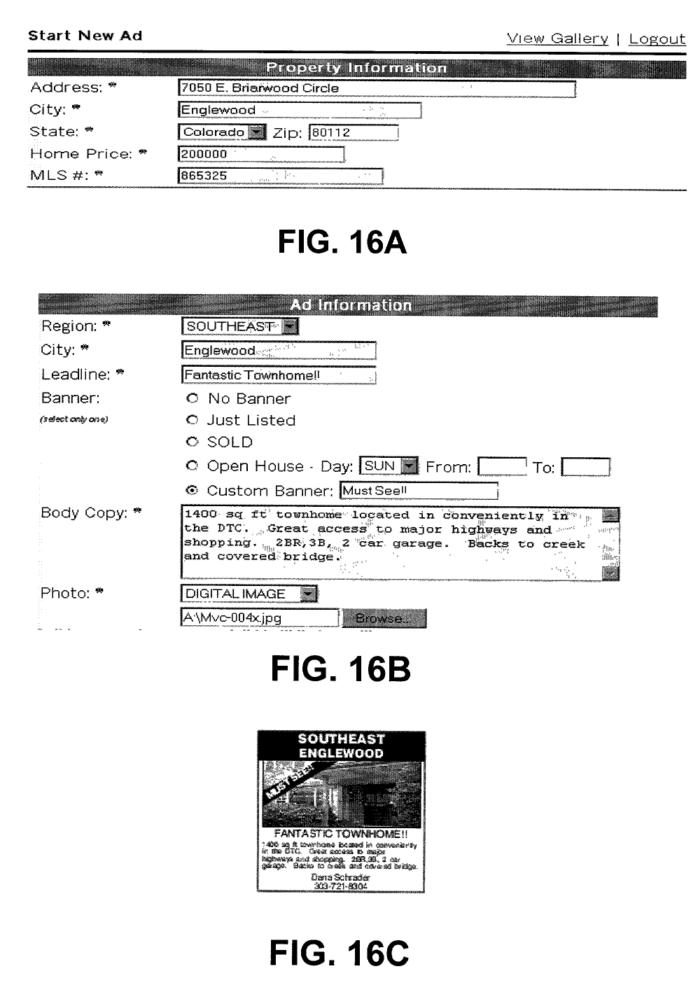

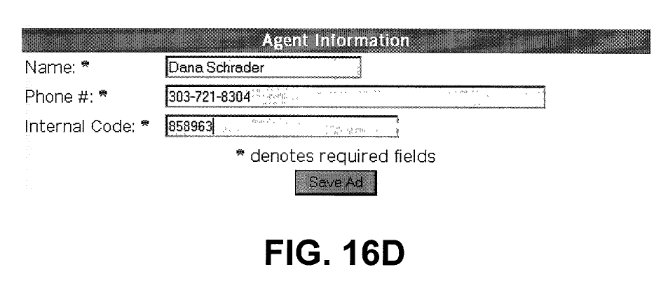

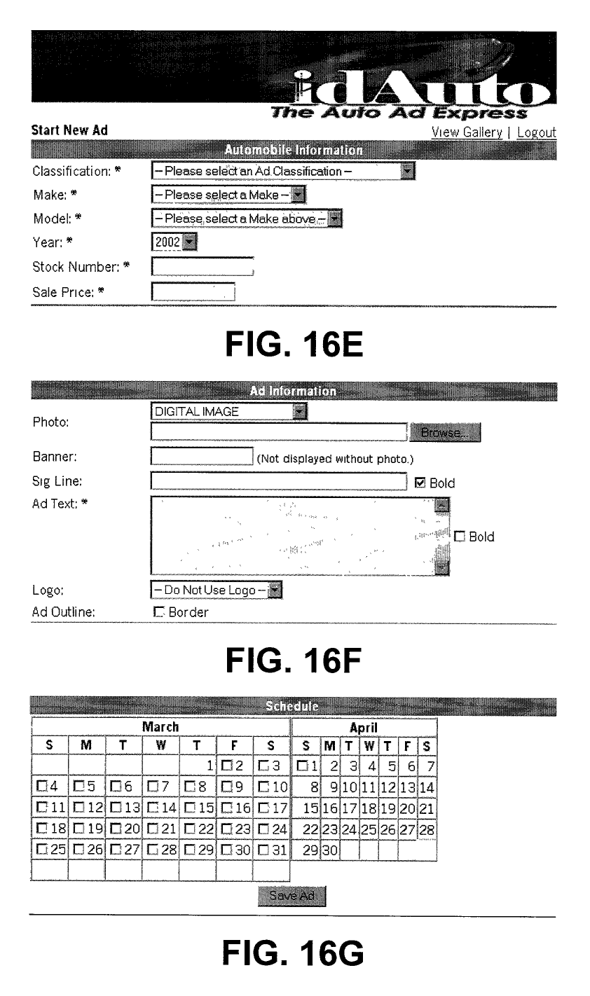

Item Details—In a non-limiting Real Estate Company example, the item details concerning a property for sale or lease are entered by a Company Agent in a screen such as the one shown in FIG. 16A. Although the item detail information may not necessarily appear in an actual Ad Box, it is necessary in order to correlate the item with the Ad Box for the Company's internal billing processes. Item details are an example of administrative data collected by the system and method of the present invention. Any type of administrative data needed by either or both the Company and the Publisher can be collected and stored in the Company and Publisher database 500 for retrieval and reporting.

Ad Box Details—The Ad Box details that directly appear in an actual Ad Box are shown in FIG. 16B. The entries are defined by Company guidelines. The Ad Box shown in FIG. 16C corresponds to the Ad Box details supplied by the Company Agent as shown in FIG. 16B.

When a Company Agent completes all the agent's Ad Boxes for that week's Ad Master, the Company Agent notifies the Company Administrator 2003, by e-mail in a preferred embodiment. All Ad Boxes created, edited, reused, and deleted are maintained in a Company and Publisher database 500, in a preferred embodiment.

Ad Type Details—In a preferred embodiment, the ad type details for a gallery ad are Company Agent details and are defaulted to a set of details obtained from Company and Publisher database 500 records of authorized Company Agents maintained by the system and method of the present invention. A selection of the Company Agent details appears in the Ad Box. The details appearing in Ad Boxes is determined by the business rules established for an embodiment. In a preferred embodiment, as illustrated in FIG. 16D, the required Company Agent details include an internal code 1601 which is used by the Company as an additional way to track ads for billing purposes. This internal code does not appear in the Ad Box.

In-Column Ad Embodiment—On initial access, a Company Agent is presented with a screen, such as the one for a non-limiting example of an Auto illustrated in FIG. 15D. After selecting “Internet Delivery Autos” 1501, the Company Agent is presented with the logon dialog box 1501, shown in FIG. 15B, and if logon is successful, the Company Agent's private gallery of Ad Boxes is listed, such as the one for an Auto Agent shown in FIG. 15E.

At this point the Company Agent may choose to delete 602, create 603 or edit 605 an Ad Box in the Company Agent's private Ad Box gallery, e.g., List of Autos for the Auto Agent shown in FIG. 15E. As shown in FIG. 15E, delete and edit functionality are accessed directly from the listing of the Company Agent's private gallery contents. Clicking on the Edit button 1505 causes an Edit Ad screen to be displayed for the corresponding Ad Box in the Company Agent's private gallery and clicking on the Delete button 1506 causes a Delete confirmation dialog box to be displayed.

In a preferred embodiment, when a new in-column Ad Box is to be created three classes of information must be supplied by the Company Agent: item details 605, Ad Box details 606, and ad type details 607, where the ad type details are ad run dates for an in-column ad.

Item Details—In a non-limiting Auto Dealership Company example, the item details concerning a vehicle for sale or lease are entered by a Company Agent in a screen such as the one shown in FIG. 16E. Although the item detail information may not necessarily appear in an actual Ad Master, it is necessary in order to correlate the item with the Ad Box for the Company's internal billing processes.

For a non-limiting example of an Auto Dealership Company, the Company Agent enter the Classification type, which refers to the section with a publication's Classified Ads in which the ad is to appear. For a typical newspaper, there are separate sections of the Classified Ads for each vehicle make and even some models. As illustrated in FIG. 16E, a drop down list is provided for an Auto Dealership Agent to select from for many of the item details to be entered, including Classification. In a preferred embodiment, the Classification selected automatically defaults the Make of vehicle. However, if the Make defaulted is not correct the Auto Dealership Sales Agent can change the defaulted value to the correct value.

In a preferred embodiment for an Auto Dealership, Model options are derived from the Make chosen. All valid Models for a given Make are included in a drop down list for an Auto Dealership Sales Agent to choose among. Year is the model year of the vehicle to be offered in the in-column ad. Stock number is the Auto Dealership Company's inventory stock number for the vehicle. It is a requirement of classified advertising for vehicles that stock numbers always be identified. Sales price is also a requirement. These are examples of required items that can be tailored to ad type.

The particular item details can be customized to the type of ad and the example of an Auto Dealership Company does not in any way limit the customization possible in the system and method of the present invention for an in-column ad.

Ad Box Detail Entries—All the information required to customize the in-column ad text entries and appearance is entered as ad box detail entries, in a preferred embodiment. The various combinations of entries that can be selected, in a preferred embodiment, include:

image, banner (no banner), sig line, ad text, logo

image, banner (no banner), ad text, logo

image, banner (no banner), ad text

sig line, ad text, logo

sig line, ad text

ad text, logo

ad text

An example of an input screen for these entries is illustrated in FIG. 16F, for a non-limiting example of an Auto Dealership Company. If an Ad Box is defined with a configuration that contains other entries, the system and method of the present invention is adaptable to whatever specification is provided for the configuration of Ad Boxes by a Company and Publisher combination. Different configurations are even possible for different classifications for each Publisher, in the system and method of the present invention.

When a Company Agent completes all Ad Boxes for that week's Ad Masters, the Company Agent notifies the Company Administrator 2003 by e-mail, in a preferred embodiment. In a preferred embodiment, all in-column Ad Boxes created, edited, reused, and deleted are maintained in a Company and Publisher database 500 until the last publication date specified for the Ad Box.

Ad Type Details—In a preferred embodiment, the in-column ad is scheduled for publication by the Company Agent, and there is no involvement of the Publisher PrePress Personnel. FIG. 16G illustrates how a Company agent goes about scheduling publication of an in-column ad. The day following the day the ad is created is the first day the in-column ad is available to be run in the classifieds of a publication. In a preferred embodiment, a deadline of 5PM is enforced for newspapers in order for the newspaper to properly retrieve and process all of a Company's in-column ads for the next publication day. This deadline for in-column ads is one of the business rules that is stored in the Company and Publisher database 500 and is tailored to the express needs of both the Company and the Publisher of each installation of the system and method of the present invention.

Company Administrator Role

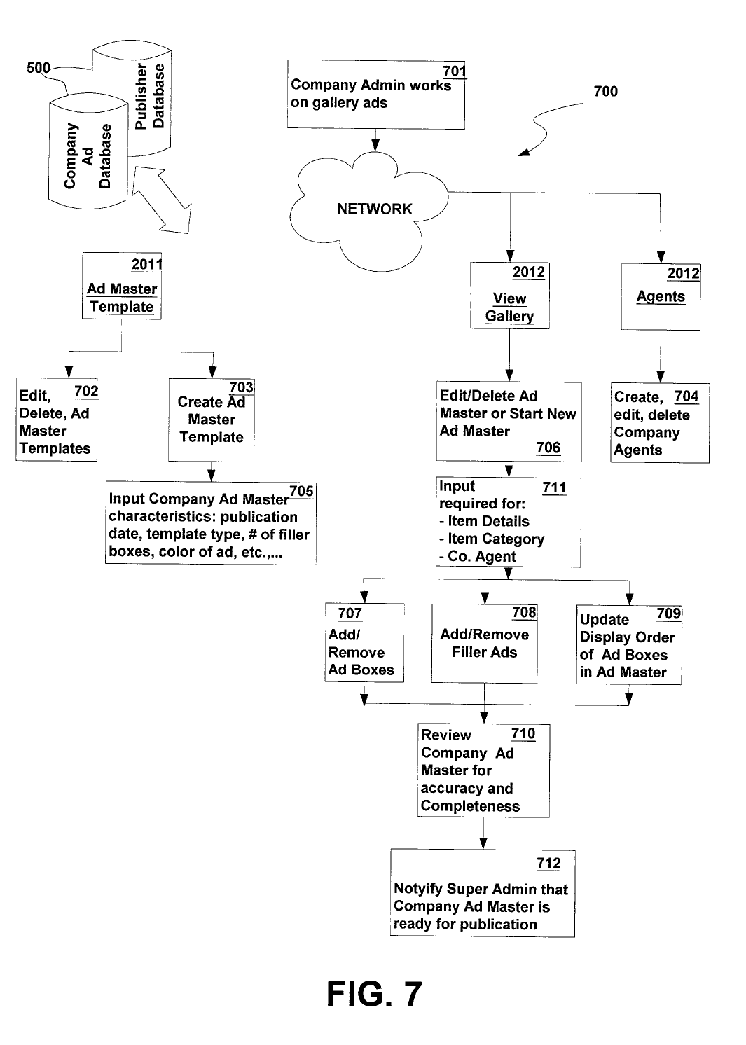

In a preferred embodiment, each Company assigns one or more of its personnel to perform the Company Administrator Role in the system and method of the present invention. Each Company Administrator is authorized to create, edit and delete Ad Masters, has access to all Company Agent Private Galleries of Ad Boxes as well as access to all of the Company's Ad Masters and Ad Master templates. FIG. 7 illustrates how a Company Administrator works on Ad Boxes 701 for gallery ads, in a preferred embodiment. The Company Administrator accesses a Hosted embodiment of the system and method of the present invention via a network, which is accomplished using a Web browser to access the Host over the Internet, in a preferred embodiment.

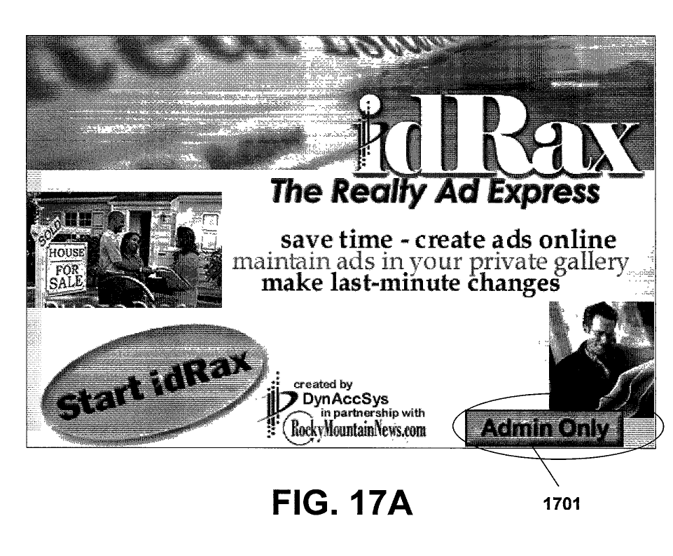

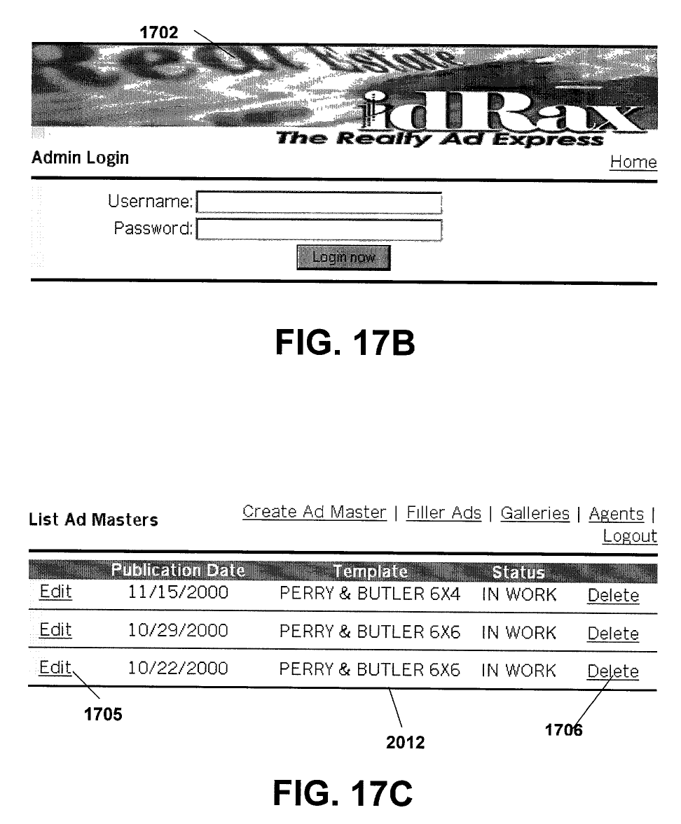

Gallery Ad Embodiment—A Company Administrator is presented with a home page screen, such as the one for a non-limiting example of a Real Estate Company home page, illustrated in FIG. 17A. After selecting “Admin Only” 1701, the Company Administrator is presented with the logon dialog box 1702, shown in FIG. 17B, and if logon is successful, a listing of the Company's gallery of Ad Master instances is displayed 2012, as illustrated in FIG. 17C.

At this point, the Company Administrator may choose to edit/delete 706, work on an Ad Master template 2011, or administer Company Agent database records 2012. As shown in FIG. 17C, delete and edit functionality are accessed directly from the listing of the Company's Ad Master instance gallery contents, which is displayed to the Company Administrator immediately following successful logon. Clicking on the Edit button 1705 causes an Edit Ad screen to be displayed for the corresponding Ad Master instance in the Company's Ad Master instance gallery and clicking on the Delete button 1706 causes a Delete confirmation dialog box to be displayed. In a preferred embodiment, when a new Ad Master instance is to be created either an existing Company Ad Master 706 or an existing Company Ad Master template 703 must be selected and Company characteristics must be entered 705.

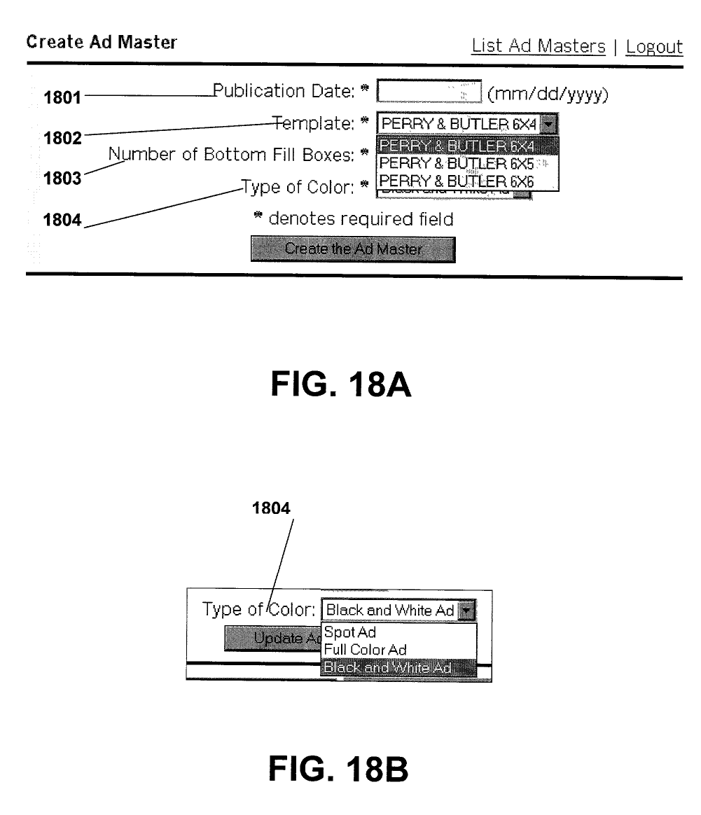

When a new Ad Master instance is to be created, in a preferred embodiment, there are several required characteristics, as shown in FIG. 18A for a non-limiting example of a Real Estate Company. As shown in FIG. 18A, the publication date 1801 must be filled in to indicate the date the gallery ad is to be published. An Ad Master template must be chosen from a drop down list of pre-stored templates. In a preferred embodiment, the size options for a template are 6×4, 6×5, and 6×6 1802. This translates into a template that is comprised of individual Ad Boxes six columns across by four, five and six rows down, respectively. The Company Administrator chooses the size based upon the number of Ad Boxes received from Company Agents for the current publication period.

The number of Bottom Fill Boxes 1803 can range from two to a maximum amount, based upon the Company's requirements. Bottom Fill Boxes are used by the Company Administrator to complete an Ad Master. The Ad Master templates are fixed in size and cannot be revised if the total number of Ad Boxes required is not received. If the Company Agent deadline has arrived, or if there is not enough participation by the Company's Agents for the current week's advertising, Bottom Fill Boxes will be needed as Ad Master components to complete the Ad Master instance. Some examples of Bottom Fill Boxes are the Company Logo, and announcement of a Company event, or sponsorship with a related Company, or anything the Company chooses to use as filler. In a preferred embodiment, three is the maximum number of Ad Boxes that can be used for a given Bottom Filler Ad. Therefore, in this preferred embodiment, two Bottom Filler Ads of three Ad Boxes, six Bottom Filler Ad of one Ad Box, or three Bottom Filler Ads of two Ad Boxes are the available options.

In a preferred embodiment, the type of color 1804 to be used in an Ad Master instance is provided in a drop down list, as illustrated in FIG. 18B. A Spot Ad is an Ad Master instance that has a colored background with black and white individual Ad Boxes. A Full Color Ad has color photographs and a colored background. A Black and White Ad is entirely grayscale, meaning black and white photos with a grayscale background.

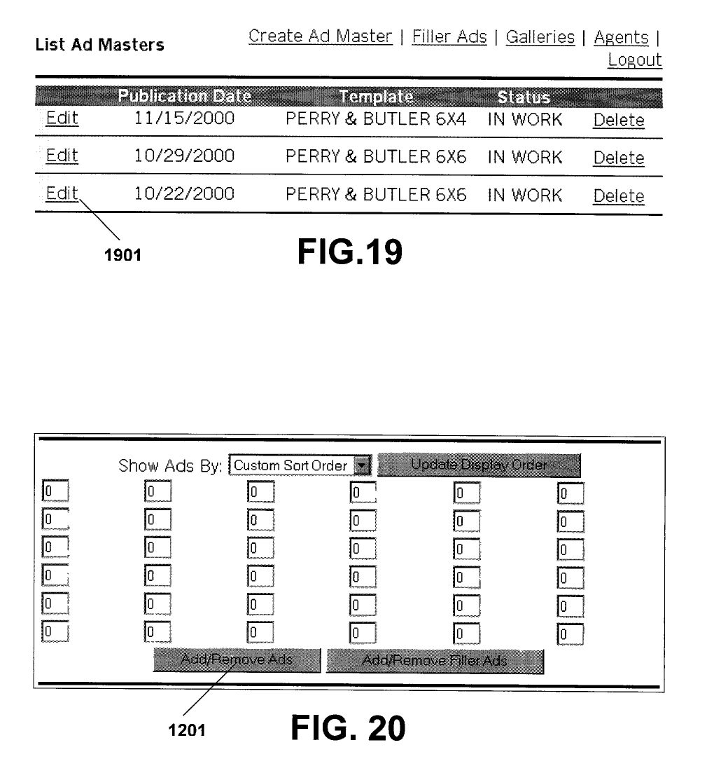

At this point, in a preferred embodiment, the Company Administrator has either selected an existing Ad Master instance or created a new Ad Master instance and in either case has entered the Ad Master's characteristics. The Company Administrator saves the Ad Master in the Company and Publisher database 500 and is presented with a listing of all the Company's Ad Master instances and their current status. As illustrated in FIG. 19, in a preferred embodiment, all Ad Master instances that have been created by the Company Administrator for the Company are contained in this display. The Ad Master instance creation process is continued by clicking on the Edit button 1901 that causes the Edit Ad Master screen of FIG. 20 to be displayed. The sort order of the Ad Master instance's component Ad Boxes is specified using this screen.

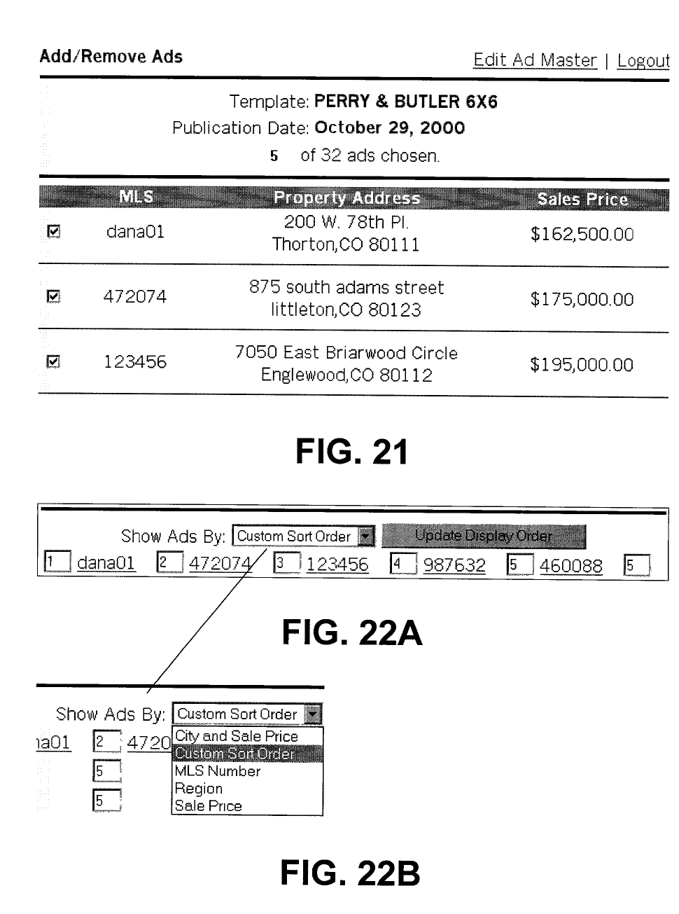

The selection and layout of component Ad Box instances that have been created by Company Agents is begun by clicking on the Add/Remove Ads button 2001, which, in a preferred embodiment, results in the display of the Add/Remove Ads listing shown in FIG. 21. Any Ad Box instances already selected are indicated and all the available Ad Box instances are listed. After the Company Administrator checks Ad Box instances to select them as components of the current Ad Master instance, the Company Administrator saves the selections in the Company and Publisher database 500 and proceeds to specify the order of the selected Ad Box instances, i.e., to layout the gallery ad. In a preferred embodiment, the sort ordering is accomplished by the Company Administrator making entries to indicate sort order in the display shown in FIGS. 22A-B.

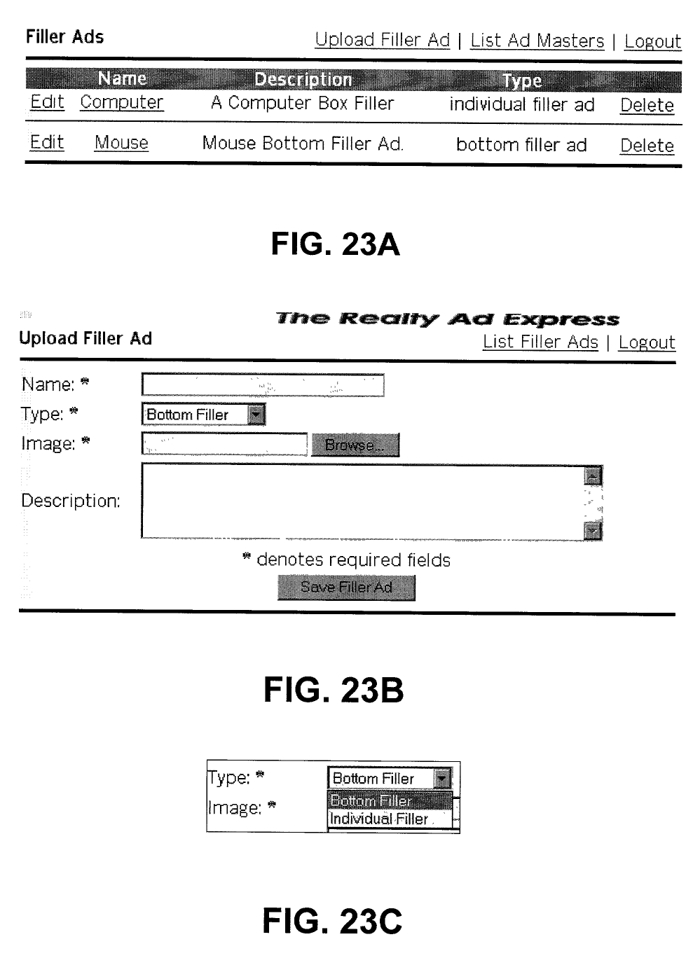

If too few Ad Box instances have been created by Company Agents for this week's gallery ad, the Company Administrator will have to add at least one Filler Ad. A listing of Filler Ads is shown in FIG. 23A. In a preferred embodiment, Filler Ads are created using the data entry display, shown in FIG. 23B. The type of Filler Ad is selected from a drop down list shown in FIG. 23C. Filler Ad Boxes are included in the display of available Ad Box instances, illustrated in FIG. 21, and are selected for inclusion in an Ad Master instance using this display.

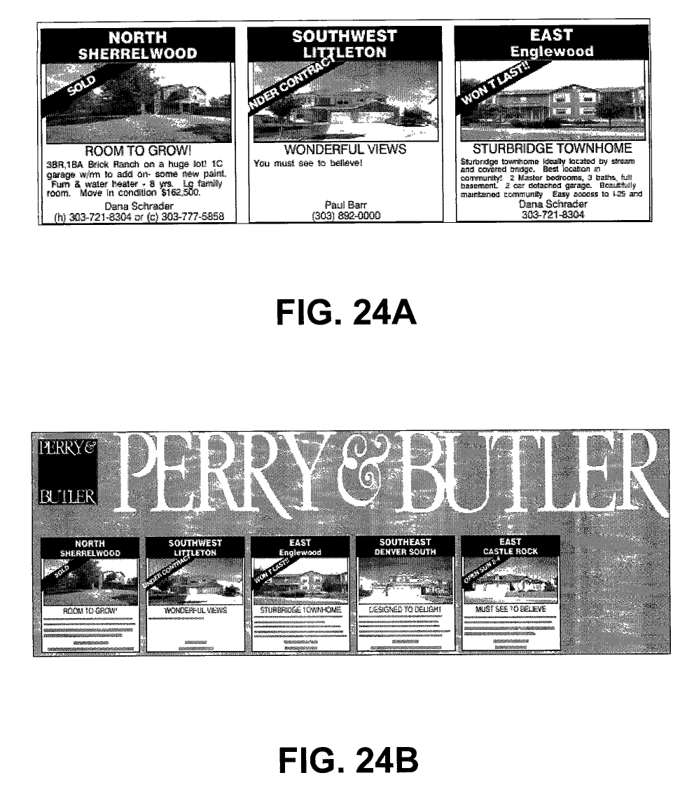

When the Company Administrator is finished laying out the Ad Box instances for an Ad Master instance, the Ad Master instance is displayed without a background image or with a background image, as shown in FIGS. 24A-B. Then the Ad Master instance is reviewed for accuracy and completeness 710, corrected, and saved in the Company and Publisher database 500. Thereafter, the Company Administrator informs the Publisher Super Administrator by e-mail that the gallery ad Ad Master instance is ready for publication 2015.

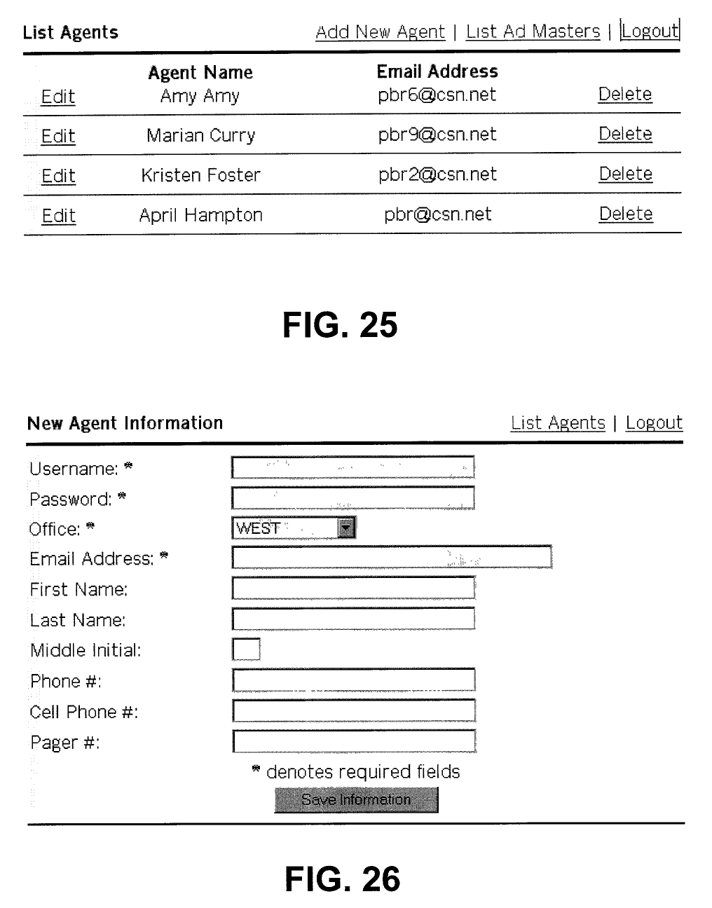

The Company Administrator is also responsible for managing Company Agent information. In a preferred embodiment, all Company Agent database records are listed for editing and deleting in a display such as that illustrated in FIG. 25. The Company Administrator adds new Company Agent database records using the display shown in FIG. 26.

In an alternative gallery ad embodiment, the Company roles can be combined. That is, a Company Agent can also perform the Company Administrator role.

In-Column Ad Embodiment—There is only one Administrator role for an in-column ad and the functions of this role that correspond to the Company Administrator role are much simpler than for gallery ads. Each Ad Box instance is associated with the active Ad Master template at the time the Company Agent creates the Ad Box. The Administrator reviews the Ad Box instance for accuracy and completeness, makes corrections, and saves the Ad Box instance in the Company and Publisher database 500. Because there is only one Ad Box component for an in-column ad there is no layout required.

Super Administrator Role

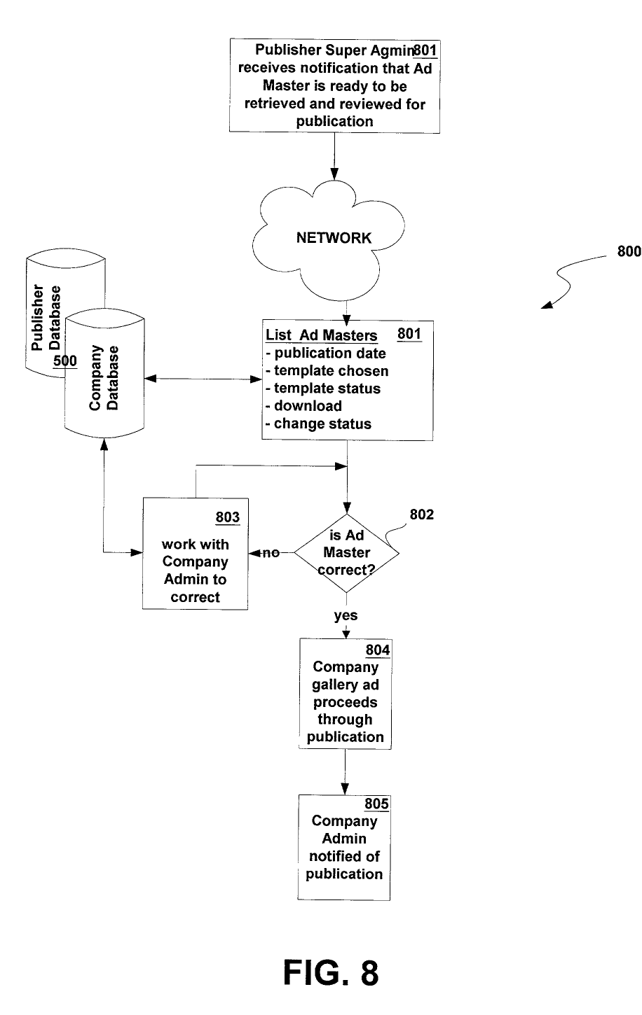

In a preferred embodiment, a Super Administrator is one of the users of the system and method of the present invention that represents the Publisher and works closely with the Company Administrator to review and correct Company Ad Master instances that are ready for publication. FIG. 8 illustrates how a Publisher Super Administrator works on Ad Master instances 2021, in a preferred embodiment. The Publisher Super Administrator accesses a Hosted embodiment of the system and method of the present invention via a network, which is accomplished using a Web browser to access the Host over the Internet, in a preferred embodiment.

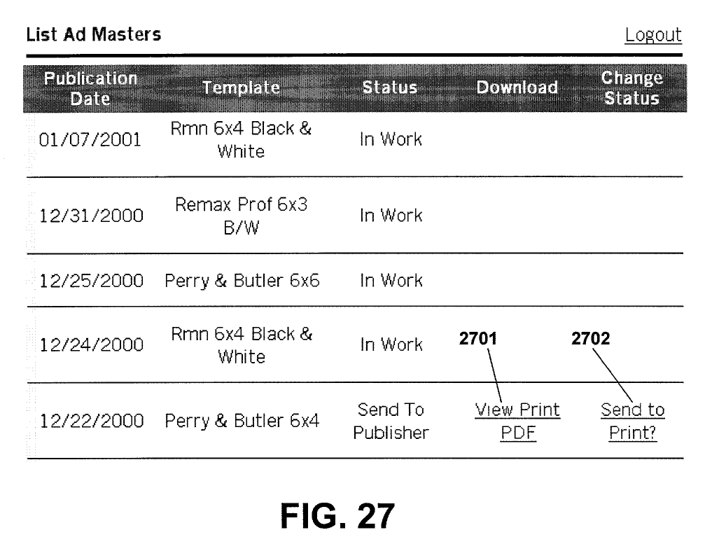

Gallery Ad Embodiment—In order to log on to a system according to the present invention, a Publisher Super Administrator is presented with a home page screen such as the one for a non-limiting example of a Real Estate Company home page, illustrated in FIG. 17A. After selecting “Admin Only” 1701, the Publisher Super Administrator is presented with the logon dialog box 1702, shown in FIG. 17B, and if logon is successful, a listing is displayed of the Ad Masters that have been submitted to the press by Company Administrators 2022, as illustrated in FIG. 27.

In a preferred embodiment, each completed Ad Master instance is converted and stored as a PDF file, and it is this PDF file that is retrieved and viewed by the Publisher Super Administrator in order to continue and finalize the gallery ad creation process. After the completed Ad Master instance has been viewed 2701 and the Publisher Super Administrator has worked with the Company Administrator to correct any deficiencies 2023 and the Ad Master instance has been finally approved, the Publisher Super Administrator notifies the Publisher PrePress Administrator 2025 by e-mail and sends the PDF to print. This action triggers a confirmation e-mail to the Company Administrator 801. The status of the Ad Master instance is changed to SENT TO PRINT by the Publisher Super Administrator 2702 and the Ad Master is locked so that it can no longer be revised by the Publisher Super Administrator.

In an alternative gallery ad embodiment, the Super Administrator role can be filled by a Company employee or combined with the Publisher PrePress Administrator role. Virtually, the system and method of the present invention can implement any distribution of roles and responsibilities.

In-Column Ad Embodiment—An Administrator fulfills this role for in-column ads in a preferred embodiment. Each completed in-column ad is converted and stored as a PDF file, and it is this PDF file that is retrieved and viewed by the Administrator in order to continue and finalize the in-column ad creation process. After the completed in-column has been reviewed, any deficiencies corrected, and has been finally approved, the Administrator notifies the Publisher and sends the PDF to print. The status of the in-column ad is changed to SENT TO PRINT by the Administrator 2702 and the in-column ad is locked so that it can no longer be revised.

For other types of ads, in a preferred embodiment, the saved format of an ad is optimized to the ad type, e.g., an appropriate format for audio ads.

PrePress Administrator Role

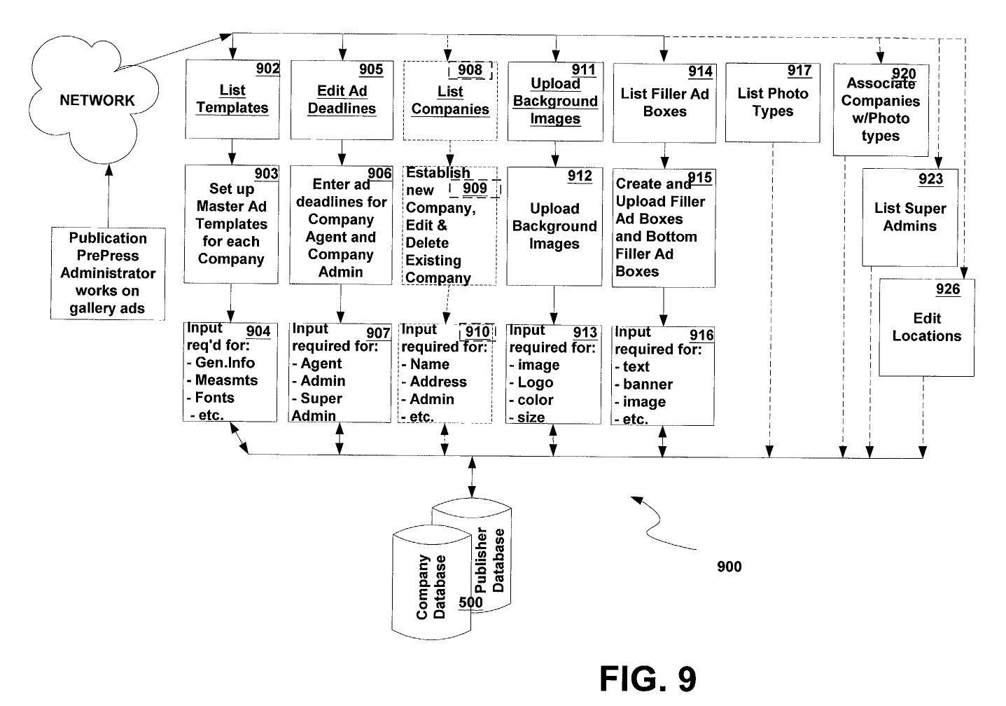

In a preferred embodiment, a PrePress Administrator is one of the users of the system and method of the present invention that represents the Publisher and who passes the final, approved Ad Master instance through the Publisher's publication process. FIG. 9 illustrates how a Publisher PrePress Administrator works on Ad Master instances 901, in a preferred embodiment. The Publisher PrePress Administrator accesses 900 a Hosted embodiment of the system of the present invention via a network, which is accomplished using a Web browser to access the Host over the Internet, in a preferred embodiment.

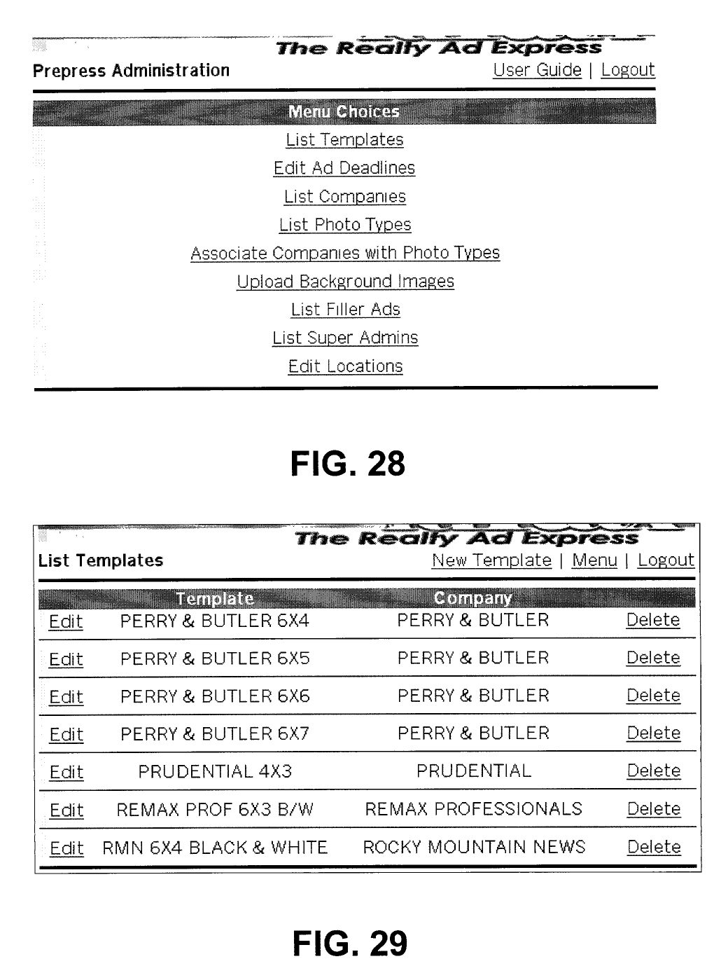

Gallery Ad Embodiment—A Publisher PrePress Administrator is presented with the home page screen, such as the one for a non-limiting example of a Real Estate Company home page illustrated in FIG. 17A. After selecting “Admin Only” 1701, the Publisher PrePress Administrator is presented with the logon dialog box 1702, shown in FIG. 17B. If logon is successful, a listing is displayed of the areas that the Publisher PrePress Administrator is responsible for, as illustrated in FIG. 28A in a preferred gallery ad embodiment and FIG. 28B in a preferred in-column ad embodiment.

For alternative preferred embodiments where there is a production department, e.g., movie theatre ads, production personnel are authorized to fulfill this role.

List Templates—The Publisher PrePress Administrator is responsible for the creation and maintenance of the Ad Master templates that, in a preferred embodiment, are stored in Company and Publisher database 500. Each gallery ad Ad Master instance of the present invention corresponds to an Ad Master template that contains the business rules for laying out components (i.e., individual Ad Box instances, logos, Filler Ads, and background images) to form an Ad Master instance. The template also provides a standard of review that is used by the Company Administrator to review Ad Master instances for accuracy, consistency and completeness before submission to the Publisher. Since each Company is competing with others and wants to stand apart from its competitors, in a preferred embodiment, the system and method of the present invention allows each Company to compile Ad Master instances that differ in color, size, format, style and logos. The Publisher PrePress Administrator accommodates Company preferences within the publication's style requirements by creating Ad Master templates having associated business rules which implement appropriate fonts, measurements, etc. from knowledge of each Company's requirements.

In a preferred embodiment, previously created Ad Master templates appear in the “List of Templates” screen, illustrated in FIG. 29. These already existing Ad Master templates can be edited, in a preferred embodiment, using a template editing screen. A new Ad Master template can also be created using this screen.

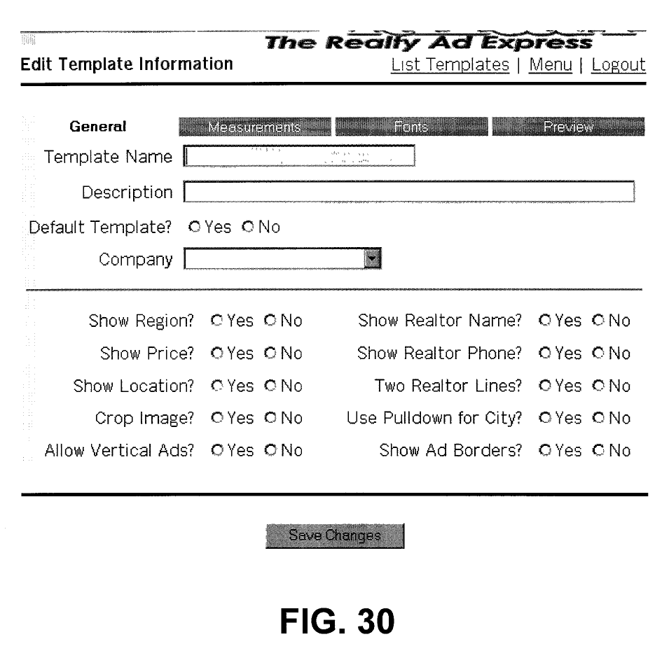

The template editing screen, in a preferred embodiment, includes four tabs, that the Publisher PrePress Administrator must select to edit or create an Ad Master template: General Information, Measurements, Fonts, and Preview. FIG. 30 is a non-limiting example of a template edit/create screen for a Real Estate Company, which includes these four tabs.

In a preferred embodiment, the General Information tab is used to provide the “Template Name”, to provide optional “Description” information, and to designate whether or not this is the “Default Template” used to designate the size of the Ad Box instances that Company Agents will be creating for inclusion in Ad Master instances whose format is controlled by this Ad Master template. In a preferred embodiment, the Ad Box size is 2×2.

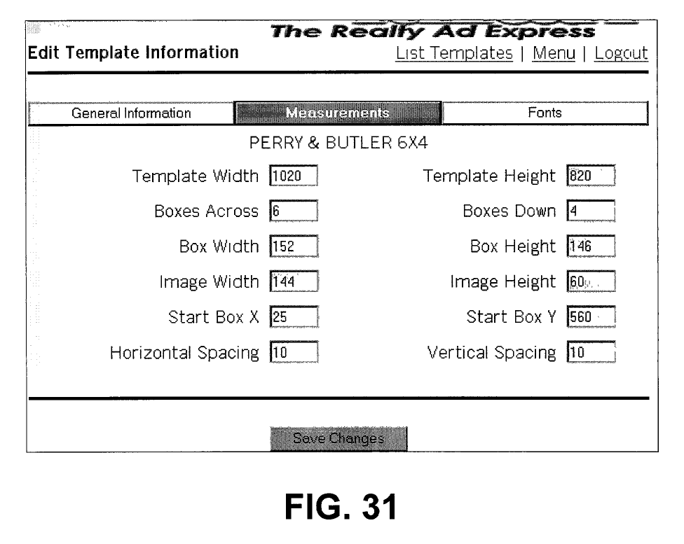

In a preferred embodiment, Measurements determine the alignment of the background image, Ad Box instance size and placement, spacing and image placement within each Ad Box instance. A Measurement input screen of a preferred embodiment is shown in FIG. 31 where all width and height measurements are in pixels. “Boxes Across” and “Boxes Down” are the number of columns and rows in a gallery ad, respectively.

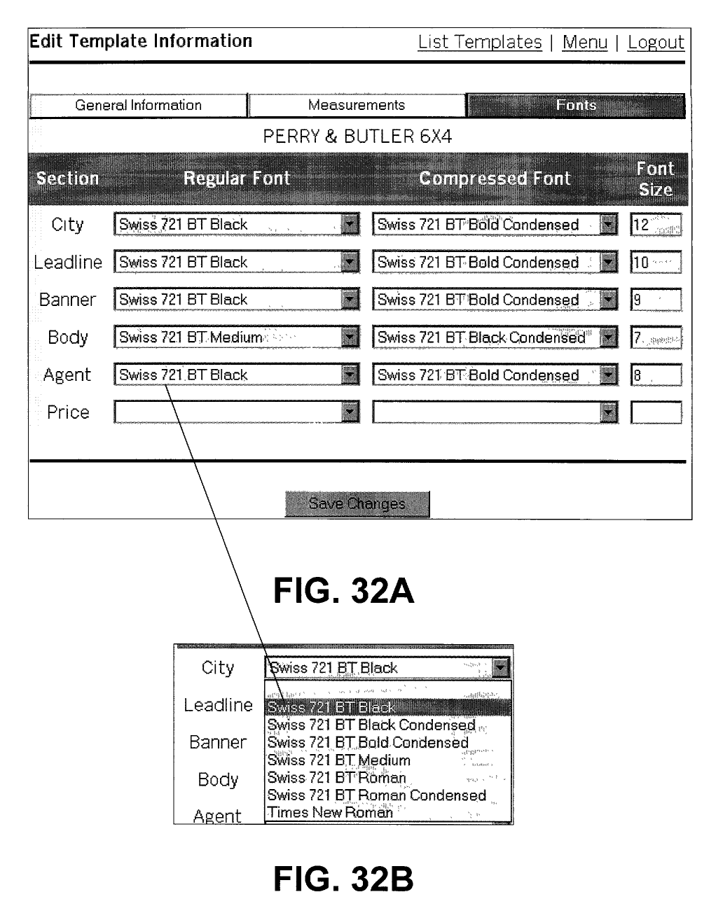

In a preferred embodiment, the Publisher PrePress Administrator is responsible for setting up the Fonts that will be used in Ad Box instances entered as components into the Ad Master instance created using an Ad Master template. FIGS. 32A-B illustrate a preferred embodiment of a screen corresponding to the Font tab. The “Regular Font” is the default font that will be used for all Ad Box instances placed as components into Ad Master instances created using an Ad Master template. In a preferred embodiment, if any text entered by a Company Agent is greater than the available space, the corresponding compressed font will automatically be used instead. If the compressed font still does not enable the complete text to be included, the font will automatically be decrease one font size. If the decreased font size is still not small enough to include all the text, the body copy must be edited or a portion of it will be truncated and not appear in the Ad Box instance when the Ad Master containing it is published.

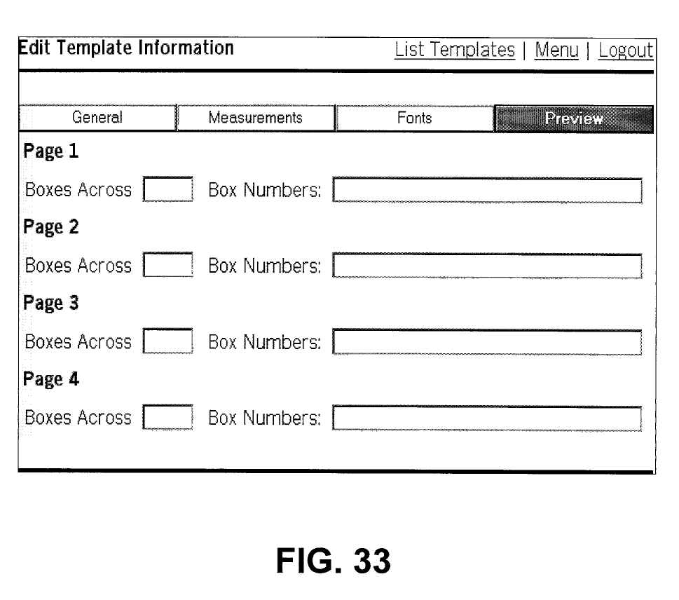

A Company Administrator may view a completed gallery ad in either Preview or Production Mode. The Production Mode displays an entire laid out Ad Master instance on one 8½×11 page. Preview Mode displays each individual Ad Box instance of the Ad Master in its original size. Therefore, only a limited number of Ad Box instances can be displayed on each page, due to space limitations. In a preferred embodiment, a screen of the type illustrated in FIG. 33 is used by the Publisher PrePress Administrator to set up the number of Ad Box instances across each Preview Mode page and the source Ad Box instance location in a laid out Ad Master instance.

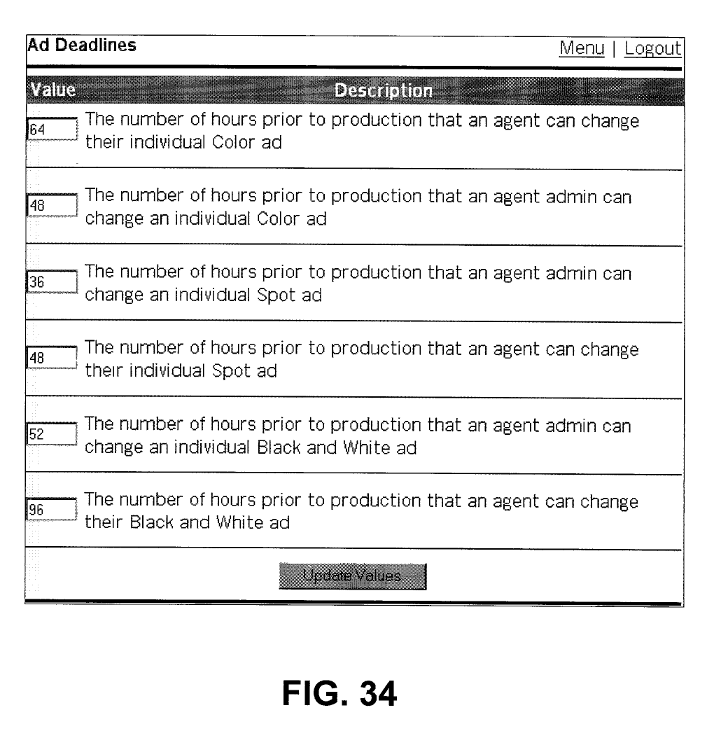

Edit Ad Deadlines—In a preferred embodiment, the Publisher PrePress Administrator is responsible for maintaining the system cutoff times for Ad Master instance submission by a Company to the Publisher. The number of hours prior to production that revisions can be made by a Company Agent and Company Administrator are stored in the Company and Publisher database 500 by making entries into the Ad Deadlines screen, illustrated in FIG. 34. The Company Administrator is the last Company employee to view and work with the individual Ad Box instances before sending the Ad Master instances containing them to the Publisher. Therefore, the deadlines specified for a Company Administrator should be closer to production time than those specified for a Company Agent.

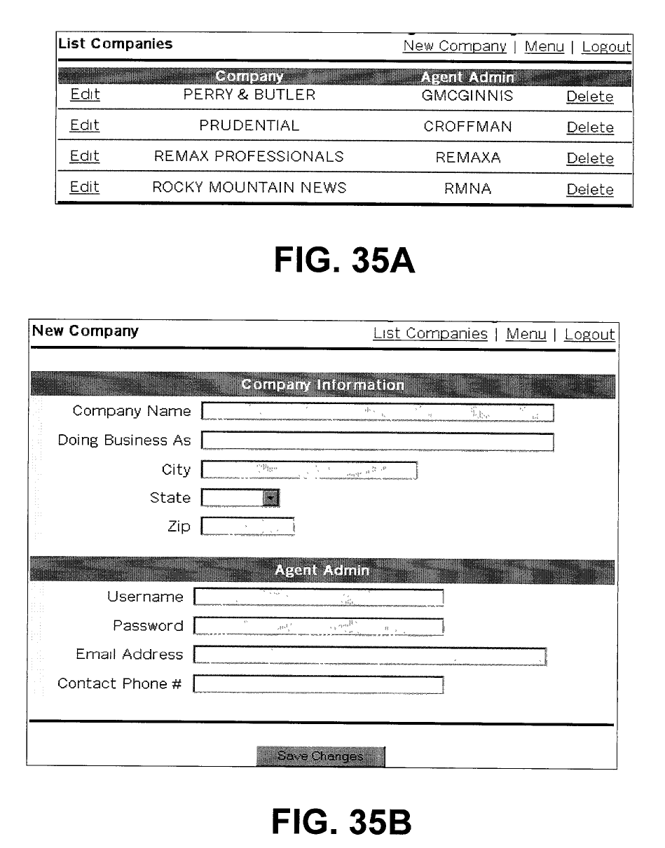

List Companies—The Publisher PrePress Administrator is responsible for setting up each new Company, in a preferred embodiment. Screens for creating, editing, and deleting Company information in the Company and Publisher database 500 are shown in FIGS. 35A-B, in a preferred embodiment. Note that not only is Company information required but also Company Administrator information is also required.

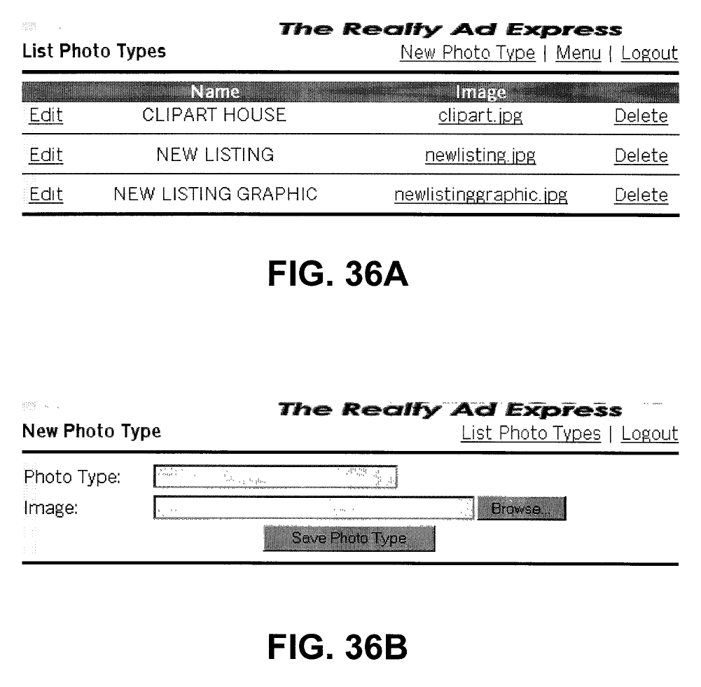

List Photo Types—In a preferred embodiment, business rules governing photo or image types must be associated with each Ad Master template. For a non-limiting example of a Real Estate Company, as shown in FIGS. 36A-B, the photo type options include: clipart house, new listing, new listing graphic. In a preferred embodiment, it is also possible to define a new photo type, as illustrated in FIG. 36B.

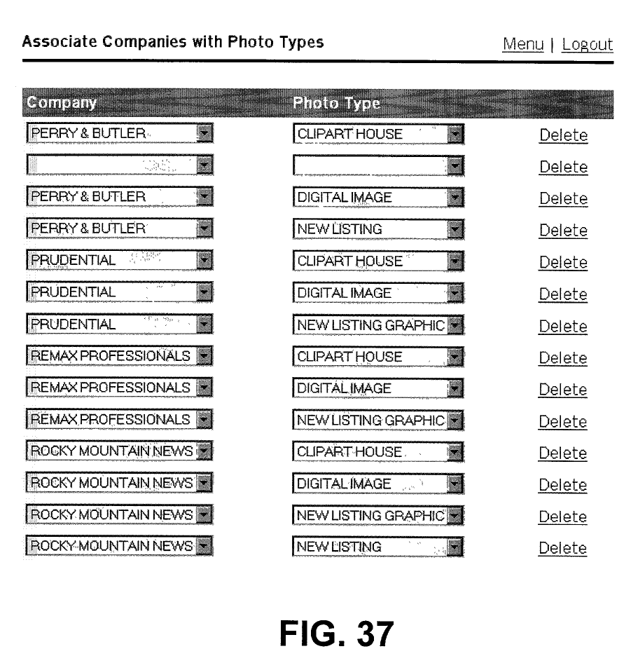

Associate Companies with Photo Types—In a preferred embodiment, photo types must be associated with a company in order for each individual type to be available to the Company Agents during Ad Box instance creation. It is the responsibility of the Publisher PrePress Administrator to designate business rules that govern which graphics can be provided as an Ad Box instance entry by a Company. The business rules for this correspondence between graphic type and Company is provided, in a preferred embodiment, using the screen illustrated in FIG. 37.

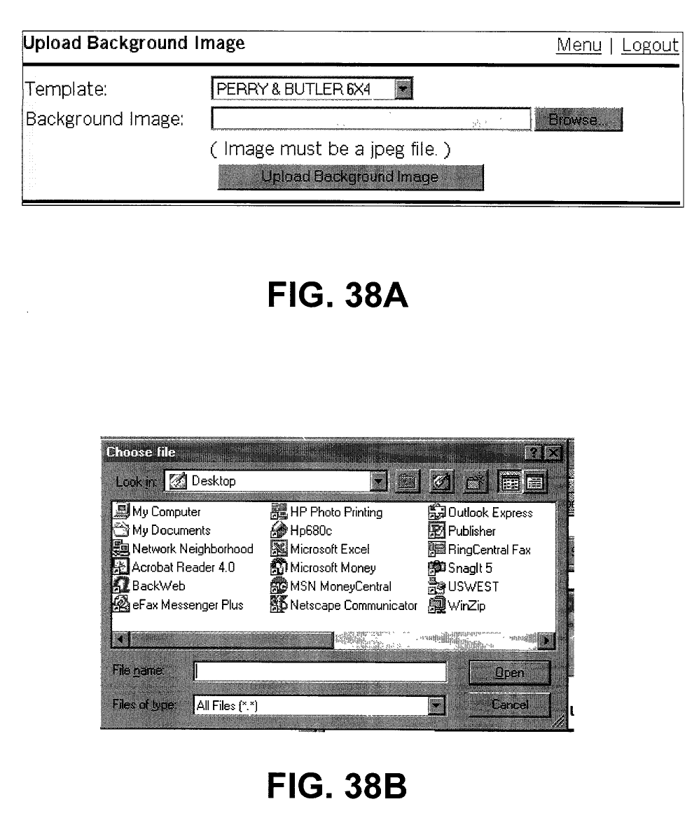

Upload Background Image—A Background Image is a border around an in-column ad and is the border around a gallery ad Ad Master instance and its component Ad Box instances. In a preferred embodiment of a gallery ad, it also includes the name of the Company, Company office location(s), Company office phone number(s), and the Company logo. The publication's art department typically creates the Background Image working in conjunction with the Company. The Background Image is stored in a file that is accessible to Publisher PrePress Administrator personnel who use the screens shown in FIG. 38A-B to select a Background Image file and upload that Background Image to a selected template.

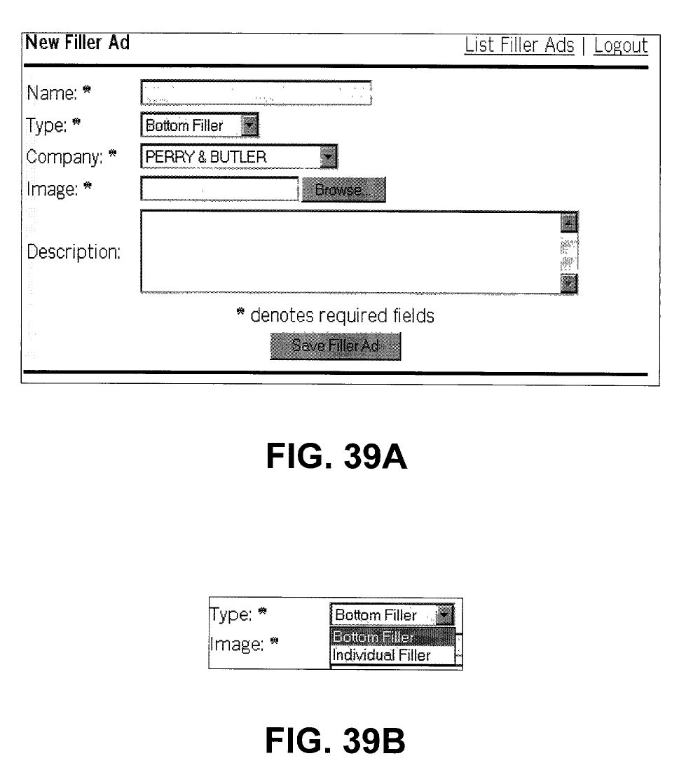

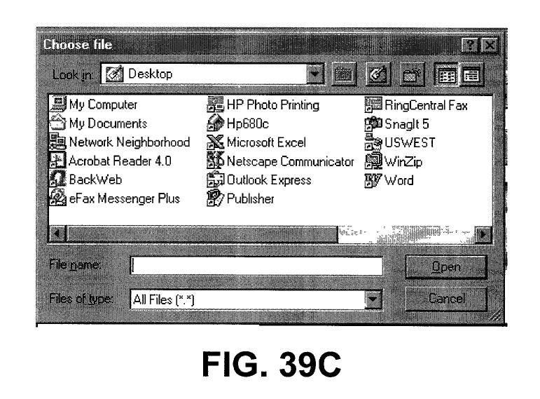

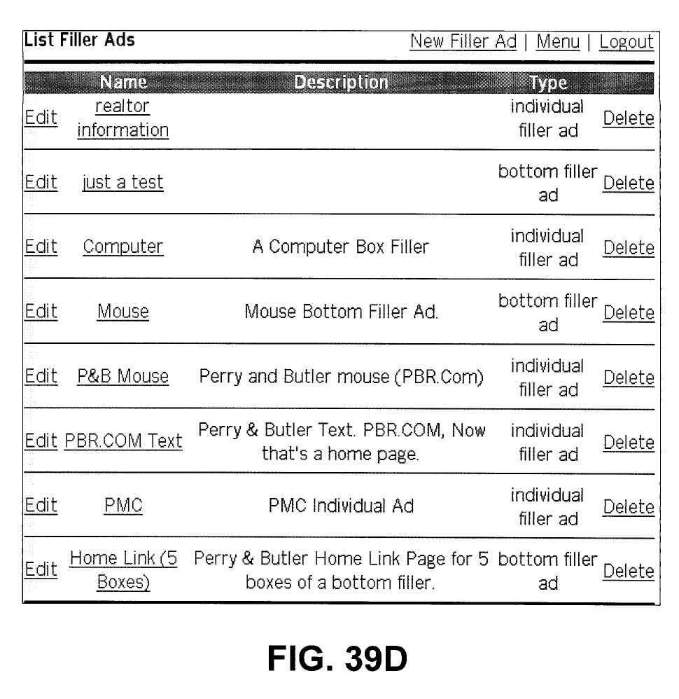

List Filler Ads—In a preferred gallery ad embodiment, Publisher PrePress Administrator personnel are responsible for creating and maintaining Filler Ads and Bottom Filler Ads that may be necessary if not enough Ad Box instances are available to completely fill a gallery ad Ad Master instance. The Publisher's art department creates both Filler Ads and Bottom Filler Ads and, as illustrated in FIGS. 39A-C, the Publisher PrePress Administrator stores them in the Company and Publisher database 500 for access by a Company's Administrator. In a preferred embodiment, a gallery ad Filler Ad can include a graphic or text used as a slogan or advertisement, is only one Ad Box in size, and is located within the body or the bottom row of a gallery ad Ad Master. Bottom Filler Ads are located only along the bottom row of a gallery ad and comprise at least two Ad Boxes. A typical list of gallery ad Filler Ads is illustrated in FIG. 39D, in a preferred embodiment.

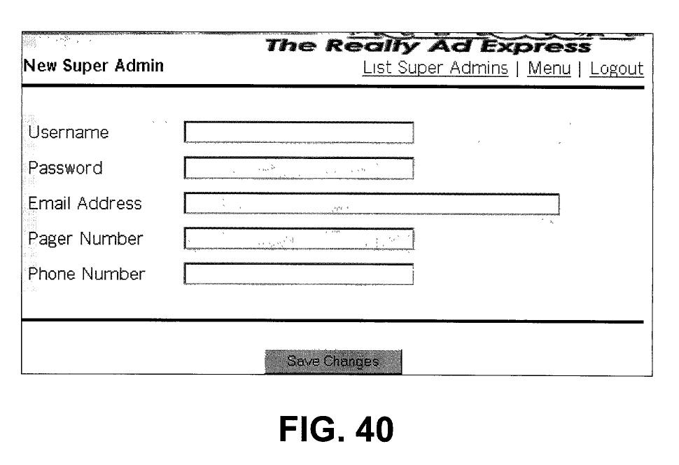

List Super Admins—Publisher PrePress Administrator personnel are responsible for setting up Host system access for Publisher Super Administrator personnel. A screen for setting up a new Publisher Super Administrator is illustrated in FIG. 40, in a preferred embodiment. The Publisher Super Administrator personnel work with Company Administrators to finalize Ad Master instances for publication.

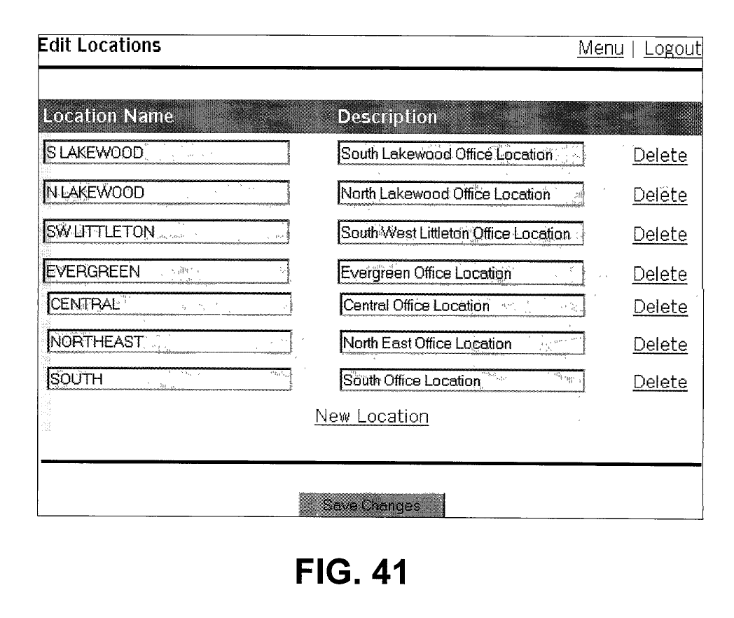

Edit Locations—Publisher PrePress Administrator personnel populate the Computer and Publisher database 500 with the office locations of each Company. All Company Agents are associated with at least one Company office so that, in a preferred embodiment, the locations of offices must be available to a Company Administrator who is setting up the system, Company and Publisher database 500 access and functional privileges for Company Agents. In a preferred embodiment, the screen illustrated in FIG. 41 is used by Publisher PrePress Administrators to edit locations of Company offices stored in database table Companies 307.

In-Column Ad Embodiment—An Administrator also fulfills this role in a preferred embodiment for in-columns ads. The functions performed for an in-column ad parallel those performed for a gallery ad. However, because in-column ads are simpler, i.e., they have a single component Ad Box instance, some of the functions required for a gallery ad are not performed for an in-column ad. The overall flow is substantially similar with the exception of those functions that are not necessary for an in-column ad. Therefore, the same flow diagrams are referred to in this discussion of in-column ad administration and a person skilled in the art will appreciate the scaled back functionality required for in-column ads.

To log on to an embodiment of the present invention, in a preferred embodiment the Administrator is presented with a home page screen, such as the one for a non-limiting example of an Automobile Dealership home page, illustrated in FIG. 15D. After selecting “Administration” 1701, the Administrator is presented with the logon dialog box 1502, shown in FIG. 17B, and if logon is successful, a listing of the Company's in-column Ad Master templates is displayed, as illustrated in FIG. 15E.

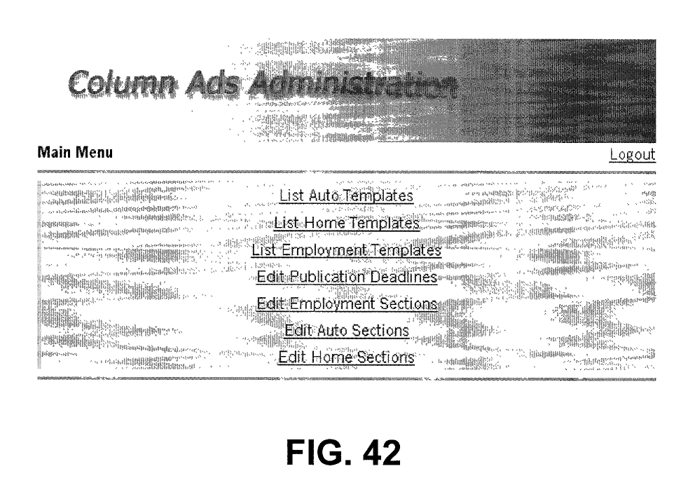

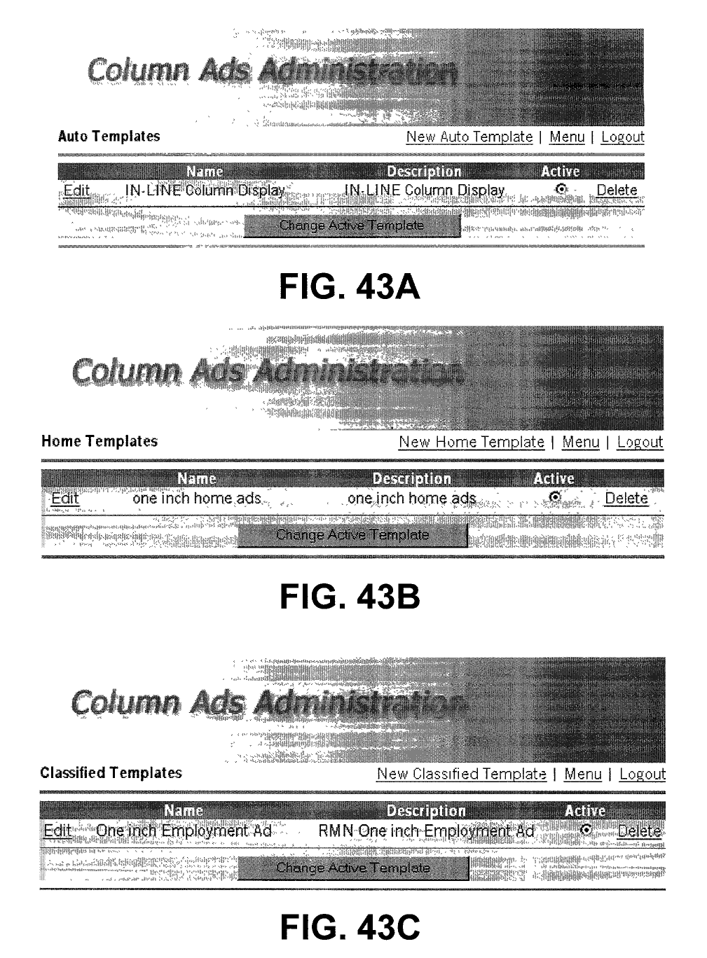

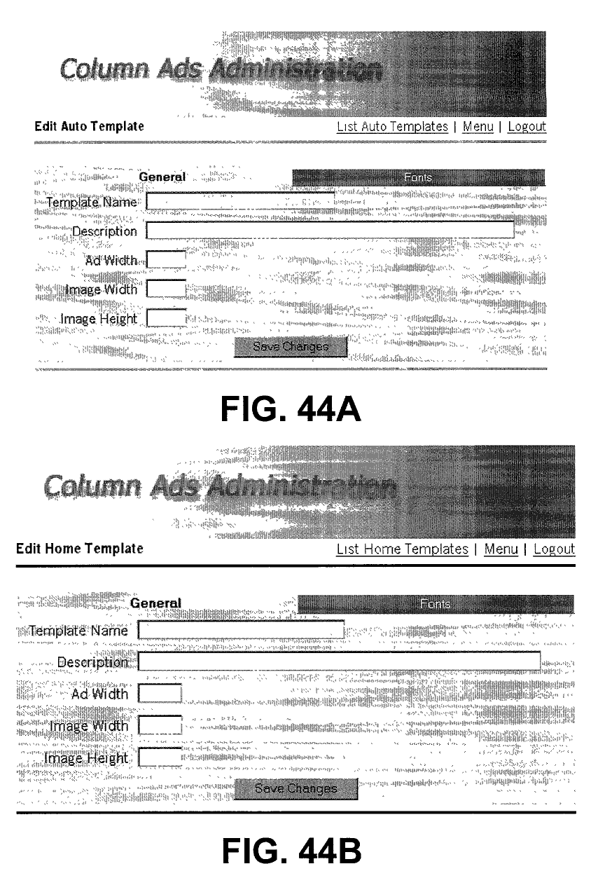

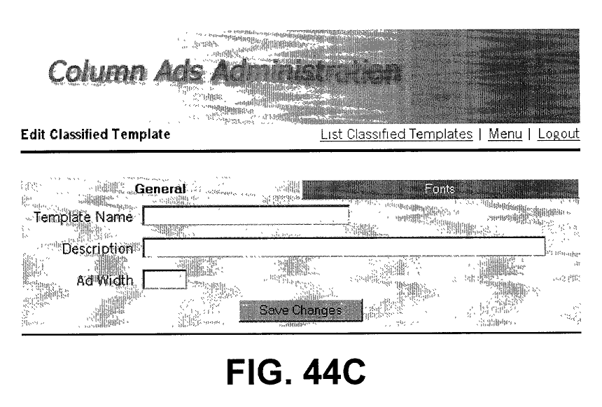

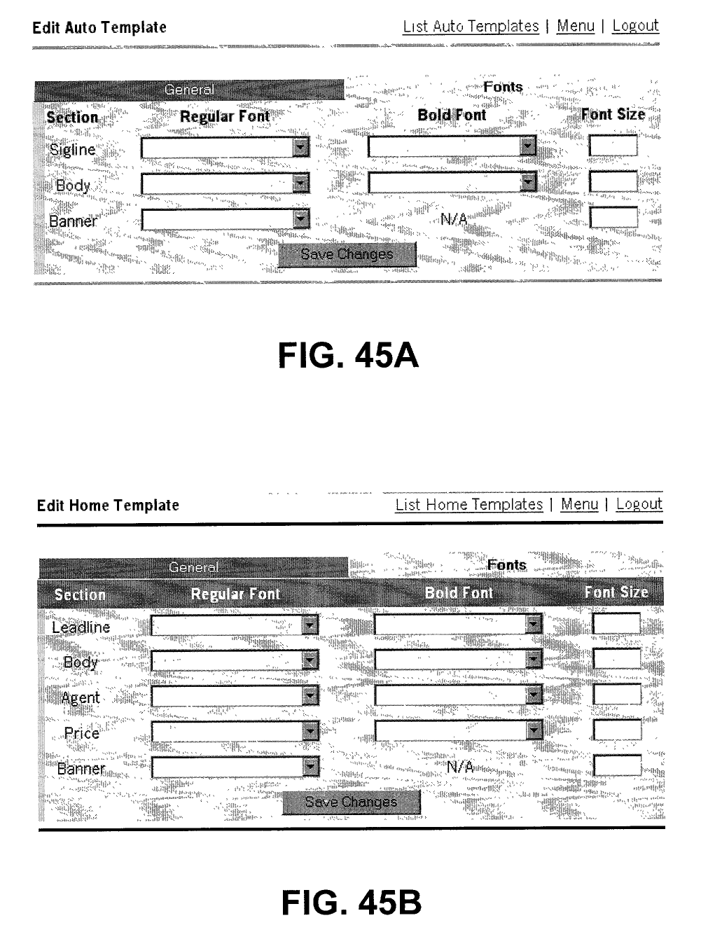

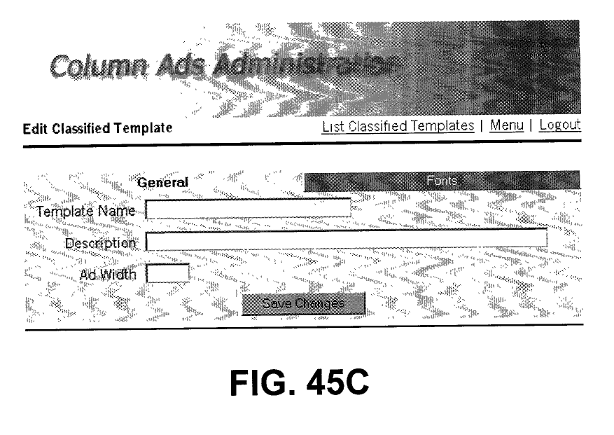

At this point, the Administrator may choose to edit/delete 706, or administer Company Agent database records 2012. Delete and edit functionality are accessed directly from the listing of the Company's Ad Master template listing contents, which is displayed to the Administrator immediately following successful logon, as illustrated in FIG. 15E and FIGS. 42A-C. Clicking on the Edit button 1505 causes an Edit Ad screen to be displayed for the corresponding Ad Master, as illustrated in FIGS. 43A-C, and clicking on the Delete button 1506 causes a Delete confirmation dialog box to be displayed. There are two categories of information, which can be edited, namely, General and Fonts. Example screens to edit these two categories of Ad Master template information are illustrated in FIGS. 44A-C and 45A-C, respectively.

The Administrator determines the in-column ad deadlines for each day by using a screen such as the one illustrated in FIG. 46. A range of possibilities is available for setting deadlines for in-column ads. The deadline options range from all in-column ads having the same deadlines to each individual type of in-column Ad Master template having a settable deadline.

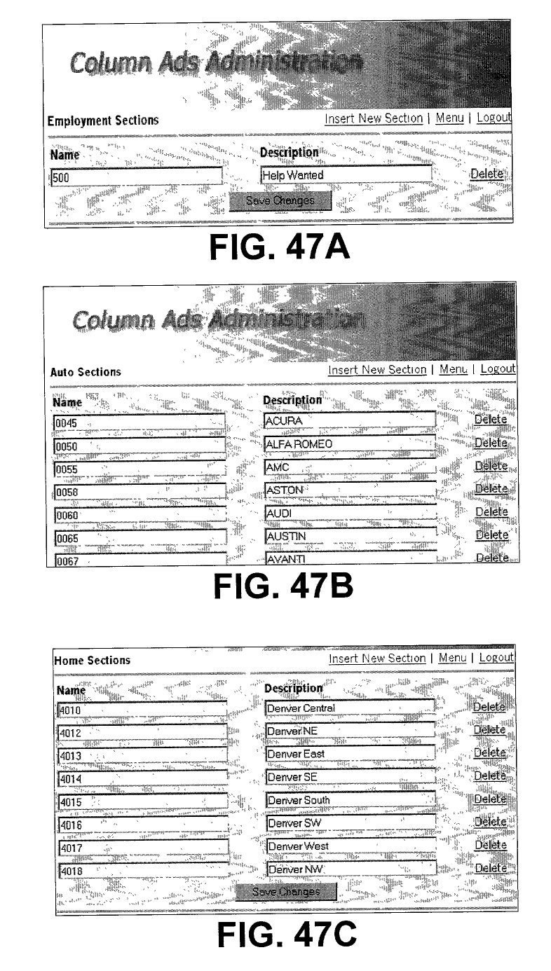

The Administrator also establishes the sections of the publication in which a particular in-column ad can appear. FIGS. 47A-C respectively illustrate screens for setting sections for employment, autos, and homes.

The Administrator is also responsible for managing the Company Agent information. In a preferred embodiment, the Company's Agent's database records are listed for editing and deleting in a display such as the one illustrated in FIG. 25. The Administrator adds new Company Agent database records using a display such as the one illustrated in FIG. 26.

In light of the foregoing detailed description, those skilled in the art will appreciate that the present invention not only improves ad creation and administration, but also includes innovative customizable support infrastructure which Companies and Publishers can tailor to their particular needs. In addition to the embodiments described above, those skilled in the art will appreciate that the teachings of the present invention may be integrated into any advertisement preparation environment, including one entirely with a Publisher's organization. Further, while a Web browser via a network has been described as a means of accessing the system of the present invention, any means of access is supported by the present invention. For example, access by cellular devices, as well as access by dedicated interaction devices, e.g., computer terminals directly connected to a host running the system and method of the present invention, are also supported Also, any set of business rules for creating, approving, storing, retrieving, publishing and administering ads of all types, not just gallery ads and in-column ads, can be supported by the system and method of the present invention.

Therefore, while the many innovative features and aspects of the present invention have been described in terms of the above illustrated embodiments, those skilled in the art will recognize that the invention is not limited to the embodiments described. In particular, the present invention may be practiced with other business rules and in other business settings, as already pointed out.

For example, those skilled in the art will also recognize that the system and method of the present invention can be applied to other advertising vehicles (than print and electronic media) that require a Company and a Publisher to cooperate to produce and publish ads, e.g., movie theatre advertisements, radio advertisements. In such applications, images can be animation or film clips, and audio tracks can be provided or created. The examples provided are illustrative only and are not limiting. The present invention can be practiced with modifications and alterations within the spirit and scope of the appended claims.

What is claimed is:

1. A preparation system with administration for ads, said system comprising:
means for specifying company advertiser and ad publisher business rules to control preparation and administration of ads for publication;
means for specifying company advertiser and ad publisher personnel roles to accomplish preparation and administration of ads for publication;
means for preparation and administration of ads for publication by said roles according to said business rules; and
a database for storing company advertiser and ad publisher business rules, personnel roles, and ads prepared and administered by said roles for publication according to said business rules;
wherein said ads are formatted for at least one ad delivery medium.

2. A preparation system with administration for ads according to claim 1, wherein said database is at least one of networked, distributed and replicated.

3. A preparation system with administration for ads according to claim 1, wherein:
said database is accessible over the Internet, and
said preparation means comprises a Web browser.

4. A preparation system with administration for ads according to claim 1, wherein said at least one delivery medium is selected from the group consisting of print, electronic, billboard, television, radio, Web page, movie film, digital recording, video recording, audio recording, and personal digital device.

5. A preparation system with administration for ads according to claim 1, wherein said means for preparation and administration of ads comprises:
at least one Ad Box default template for preparing an Ad Box instance of an ad for an individual item, said Ad Box instance having a status for indicating its stage of preparation and administration, said Ad Box default template defining a plurality of entries for each said Ad Box instance; and
at least one Ad Master template for preparing the layout of an Ad Master instance, said Ad Master instance having a status for indicating its stage of preparation and administration, said Ad Master template defining a plurality of components for each said Ad Master instance, said plurality of components comprising at least one said Ad Box instance.

6. A preparation system with administration for ads according to claim 5, wherein said means for specifying company advertiser and ad publisher business rules to direct ad preparation and administration and provide administrative control by said system comprises:
a plurality of business rules governing preparation and administration of ads, each of said plurality of business rules being specified by at least one of a company advertiser and ad publisher, each of said plurality of entries defined by said at least one default Ad Box template being associated with and controlled by at least one of said plurality of business rules, and each of said plurality of components defined by said at least one Ad Master template being associated with and controlled by at least one of said plurality of business rules; and
database storing of said at least one Ad Box default template comprising each of said plurality of entries and associated business rules;
database storing of said at least one Ad Master template comprising each of said plurality of components and associated business rules.

7. A preparation system with administration for ads according to claim 6, wherein said plurality of business rules comprises:
at least one business rule for determining Ad Box instance submission deadlines;
at least one business rule for determining Ad Master instance submission deadlines;
at least one business rule for determining at least one attribute of each of said plurality of entries for each said Ad Box instance; and
at least one business rule for determining at least one attribute of each of said plurality of components of each Ad Master instance.

8. A preparation system with administration for ads according to claim 7, wherein said at least one attribute of each of said plurality of entries for each said Ad Box instance is selected from the group consisting of width, height, font, font size, font spacing, font resizing, image size, image type, audio length, video length, color, and default size.

9. A preparation system with administration for ads according to claim 7, wherein said at least one attribute of each of said plurality of components for each said Ad Master instance is selected from the group consisting of number of rows, number of columns, Ad Box ordering, background image, number of filler boxes, Ad Box instance entry uniformity, and color.

10. A preparation system with administration for ads according to claim 6, wherein said means for specifying company advertiser and ad publisher roles comprises:
a plurality of roles for preparation and administration of ads, each of said plurality of roles being assumable by at least one of company advertiser personnel and ad publisher personnel, at least one of said plurality of roles being associated with each said Ad Box default template, and at least one of said plurality of roles being associated with each said Ad Master template; and
database storing of said plurality of roles and the association of each said role with each said Ad Box default template and with each said Ad Master template.

11. A preparation system with administration for ads according to claim 10, wherein each of said plurality of roles performs at least one of:
creation, editing and database storing of said at least one Ad Box default template and said associated business rules,
creation, editing and database storing of said at least one Ad Master template and said associated business rules,
creation, editing, approval, setting said status, and database storing of Ad Box instances of said at least one Ad Box default template according to said associated business rules, and
creation, editing, sending to publisher, setting said status, and database storing of Ad Master instances of said at least one Ad Master template, said creating and editing accomplished by retrieving from said database and laying out said Ad Box instances in said Ad Master instances according to said associated business rules; and
retrieval from said database, review, rejection, approval, sending to print and setting said status of said Ad Master instances.

12. An ad preparation system with administration according to claim 10 wherein said means for preparation and administration of ads further comprises:
database accessing by said associated at least one of said plurality of roles to at least one of said Ad Box default templates to perform at least one of creating, editing and approving Ad Box instances and setting said status of Ad Box instances according to said associated business rules;
database storing by said associated at least one of said plurality of roles of said Ad Box instances;
database accessing by said associated at least one of said plurality of roles to said at least one Ad Master template and said Ad Box instances to perform one of creating, editing, and sending to publisher Ad Master instances and setting said status of Ad Master instances, said Ad Master instances comprising at least one of said Ad Box instances as one of said plurality of components according to said associated business rules; and
database storing by said associated at least one of said plurality of roles of said Ad Master instances;
wherein ads are prepared and administered as Ad Master instances comprising Ad Box instances by said roles according to said associated business rules.

13. An ad preparation system with administration according to claim 5 wherein said plurality of components further comprises at least one filler box, said filler box having a plurality of predetermined entries.

14. An ad preparation system with administration according to claim 5, wherein said plurality of entries further comprises at least one required entry.

15. An ad preparation system with administration according to claim 14, wherein each of said plurality of required entries is selected from the group consisting of lead line, image, audio, video, automation, geographic location display, signal (sig) line, and ad body text.

16. An ad preparation system with administration according to claim 5, wherein said plurality of entries further comprises at least one optional entry.

17. An ad preparation system with administration according to claim 16, wherein each of said optional entries is selected from the group consisting of banner, first line of company data, second line of company data and dollar amount.

18. An ad preparation system with administration according to claim 15, wherein said plurality of entries further comprises at least one optional entry.

19. An ad preparation system with administration according to claim 18, wherein each of said optional entries is selected from the group consisting of banner, first line of company data, second line of company data, and dollar amount.

20. A method for ad preparation with administration, comprising the steps of:
(a) specifying company advertiser and ad publisher business rules to control preparation and administration of ads for publication;
(b) specifying company advertiser and ad publisher personnel roles to accomplish preparation and administration of ads for publication;
(c) preparing and administering ads for publication by said specified roles according to said specified business rules for delivery by at least one delivery medium;
(d) storing said specified business rules and roles in a database; and
(e) storing said prepared ads in a database.

21. The method for ad preparation with administration according to claim 20, wherein the step (c) further comprises the steps of:
i. providing at least one Ad Box default template for preparation of an Ad Box instance of an ad for an individual item;
ii. defining in said at least one Ad Box default template a plurality of entries for each said Ad Box instance said plurality of entries comprising a status for indicating its stage of preparation and administration; and
iii. providing at least one Ad Master template for preparation of the layout of an Ad Master instance;
iv. defining in said at least one Ad Master template a plurality of components for each said Ad Master instance, said plurality of components comprising at least one said Ad Box instance and a status for indicating its stage of preparation and administration; and
v. storing said at least one Ad Box default template and said at least one Ad Master template in a database.

22. The method for ad preparation with administration according to claim 21, wherein step (a) further comprises the steps of:
i. providing a plurality of business rules governing preparation and administration of ads, each of said plurality of business rules being provided by at least one of a company advertiser and ad publisher,;
ii. associating each of said plurality of entries with at least one of said provided plurality of business rules;
iii. associating each of said plurality of components with at least one of said provided plurality of business rules;
iv. storing in a database said each of said plurality of business rules and said association with said entries and said components.

23. The method for ad preparation with administration according to claim 21, wherein step (d) further comprises the steps of:
i. providing a plurality of roles for preparation and administration of ads;
ii. assuming each of said roles by at least one of company advertiser personnel and ad publisher personnel;
iii. associating at least one of said plurality of roles with each said Ad Box default template;
iv. associating at least one of said plurality of roles with each said Ad Master template; and
v. storing in a database said plurality of roles and said association of at least one of said plurality of roles with said Ad Box default template and said Ad Master template.

24. The method for ad preparation with administration according to claim 23, wherein step (d) further comprises the steps of:
vi. creating, editing, and storing in a database by said associated at least one of said plurality of roles of said at least one Ad Box default template and said associated business rules;
vii. creating, editing, and storing in a database by said associated at least one of said plurality of roles of said at least one Ad Master template and said associated business rules;
viii. creating, editing, approving, setting said status, and storing in a database by said associated at least one of said plurality of roles of Ad Box instances of said at least one Ad Box default template in accordance with said associated business rules;
ix. creating an Ad Master instance of at least one Ad Master template by said associated at least one of said plurality of roles;
x. retrieving from said database, laying out and setting said status of said at least one created, edited and approved Ad Box instance in said created Ad Master instance in accordance with said associated business rules by said associated at least one of said plurality of roles; and
xi. storing in said database of said at least one laid out Ad Master instance by said associated at least one of said plurality of roles.

25. A preparation system with administration for ads according to claim 1, said system further comprising:
a host system;
data storage means within said host system for maintaining said database containing a plurality of ad data records of differing types, including: companies, publisher, ads, templates, ad masters, roles, boxes, and fonts,
a plurality of remote communications facilities;
communication network means for exchanging data between said host computer system and each of said plurality of remote communications facilities;
computer processing means associated with said host enabling said host to accept and store, and retrieve and transmit database records from and to, respectively, one of said remote communications facilities according to criteria provided by said one of said plurality of remote communications facilities, and
computer input means at each remote communications facility permitting company advertiser personnel and ad publisher personnel at remote communications facilities to
a. specify the inputs to define said company advertiser and ad publisher personnel roles and business rules,
b. implement said personnel roles, and
c. prepare and administer ads for publication.

26. A preparation system with administration for ads according to claim 25, wherein the communications network means is the Internet and said computer input means employs a Web browser.
